(19) United States
(12) Patent Application Publication
(10) Pub. No.: US 2019/0147422 A1
(43) Pub. Date: May 16, 2019

(54) AUTOMATED TRANSACTION MACHINE, COMMUNICATION TERMINAL, AUTOMATED TRANSACTION SYSTEM, AND PROGRAM

(71) Applicant: OKI ELECTRIC INDUSTRY CO., LTD., Tokyo (JP)

(72) Inventor: Hitotoshi MURAKAMI, Tokyo (JP)

(73) Assignee: OKI ELECTRIC INDUSTRY CO., LTD., Tokyo (JP)

(21) Appl. No.: 16/309,547

(22) PCT Filed: Apr. 6, 2017
(86) PCT No.: PCT/JP2017/014372

§ 371 Date: Dec. 13, 2018

(30) Foreign Application Priority Data
Aug. 24, 2016 (JP) 2016-163177
Sep. 14, 2016 (JP) 2016-179299

(51) Int. Cl. G06Q 20/10; G06Q 20/38; G06Q 20/32

(52) U.S. Cl. CPC G06Q 20/1085; G06Q 20/3274; G06Q 20/3825

(57) ABSTRACT

[Object] To provide an automated transaction machine, a communication terminal, an automated transaction system, and a program that enable a host computer side to always recognize situations of transactions with users and results of the transactions.

[Solution] The automated transaction machine includes: a transaction data reception portion configured to receive transaction data generated by a communication terminal connectable with a host computer, the transaction data including a content of a transaction with a user of the communication terminal; a transaction execution portion configured to execute the transaction with the user on the basis of the transaction data received by the transaction data reception portion; and a transaction result transmission portion configured to transmit a result of a transaction with at least one user executed by the transaction execution portion, to the host computer via a communication terminal whose transaction data has been received by the transaction data reception portion.

### TECHNICAL FIELD

The present invention relates to an automated transaction machine, a communication terminal, an automated transaction system, and a program.

### BACKGROUND ART

Automated transaction systems have been widespread conventionally. Customers using such an automated transaction system are capable of performing cash depositing/dispensing processes and bank transfer processes without going to banking office counters of financial institutions. For example, an automated transaction system includes automated transaction machines and a host computer. The automated transaction machines are operated by customers to deposit/dispense cash. The host computer stores information related to accounts of the customers. In addition, in recent years, internet banking that uses the Internet has been widespread as another form of the automated transaction system. For example, Patent Literature 1 discloses a transaction process system in which an ATM communicates with a host machine via a mobile phone of a user, transmits an authentication request of a transaction, and receives an authentication result indicating whether or not the transaction is permitted.

### CITATION LIST

### Patent Literature

Patent Literature 1: JP 2013-117849A

### SUMMARY OF INVENTION

### Technical Problem

As described above, the popularization of automated transaction machines enables users to easily deposit/withdraw cash in/from accounts of financial institutions. However, since transactions with financial institutions are important, more improvement in convenience and safety has been desired.

For example, in view of improvement in convenience of transactions, it is preferable to manufacture the automated transaction machines at low cost and to install more machines in places familiar to users. In addition, in view of safety of transactions, it is preferable to prevent a glance at operation of a machine and to prevent hacking.

In addition, for example, in the case of sudden communication interruption of an automated transaction machine, sometimes a host computer cannot recognize real situations of the automated transaction machine and the user such as a situation of a transaction with the user and a state of the machine. In view of safety of transactions with users, it is preferable that the host computer side always recognizes situations of transactions with users and states of machines.

In a nod to the above-described issues, the present invention provides an automated transaction machine, a communication terminal, an automated transaction system, and a program that enable a host computer side to always recognize situations of transactions with users and results of the transactions. In addition, according to the present invention, it is possible to provide an automated transaction machine, a communication terminal, an automated transaction system, and a program that enable the host computer side to always recognize operational situations of the machine. In addition, according to the present invention, it is possible to provide an automated transaction machine, a communication terminal, an automated transaction system, and a program that secure high transaction safety at low cost.

### Solution to Problem

According to the present invention, an automated transaction machine includes: a transaction data reception portion configured to receive transaction data generated by a communication terminal connectable with a host computer, the transaction data including a content of a transaction with a user of the communication terminal; a transaction execution portion configured to execute the transaction with the user on the basis of the transaction data received by the transaction data reception portion; and a transaction result transmission portion configured to transmit a result of a transaction with at least one user executed by the transaction execution portion, to the host computer via a communication terminal whose transaction data has been received by the transaction data reception portion.

In addition, according to the present invention, a communication terminal is portable, the communication terminal including: a transaction data generation portion configured to generate transaction data including a content of a transaction with a user; an interface configured to output the transaction data generated by the transaction data generation portion to an automated transaction machine, and cause the automated transaction machine to execute the transaction with the user on the basis of the transaction data; and a telephone network communication portion configured to communicate with a host computer via a telephone network, and transmit a result of a transaction with at least one user of the automated transaction machine to the host computer.

In addition, according to the present invention, an automated transaction system includes: a communication terminal that is portable and connectable with a host computer, and an automated transaction machine that is connectable with the communication terminal. The communication terminal includes a transaction data generation portion configured to generate transaction data including a content of a transaction with a user, and an interface configured to output the transaction data generated by the transaction data generation portion to the automated transaction machine. The automated transaction machine includes a transaction data reception portion configured to receive the transaction data via the interface; a transaction execution portion configured to execute the transaction with the user on the basis of the transaction data received by the transaction data reception portion; and a transaction result transmission portion configured to transmit a result of a transaction with at least one user executed by the transaction execution portion, to the host computer via the communication terminal whose transaction data has been received by the transaction data reception portion.

In addition, according to the present invention, a program causes a communication terminal to operate as a transaction data generation portion configured to generate transaction data including a content of a transaction with a user; an interface configured to output the transaction data generated by the transaction data generation portion to an automated transaction machine, and cause the automated transaction machine to execute the transaction with the user; and a telephone network communication portion configured to communicate with a host computer via a telephone network, and transmit a result of a transaction with at least one user of the automated transaction machine to the host computer.

In addition, according to the present invention, an automated transaction machine includes: a transaction data reception portion configured to receive transaction data generated by a communication terminal connectable with a host computer, the transaction data including a content of a transaction with a user of the communication terminal; a transaction execution portion configured to execute the transaction with the user on the basis of the transaction data received by the transaction data reception portion; and an operational state transmission portion configured to transmit an operational state of the transaction execution portion to the host computer via the communication terminal, the operational state being obtained when the transaction data reception portion has received the transaction data.

In addition, according to the present invention, a communication terminal is portable, the communication terminal including: a transaction data generation portion configured to generate transaction data including a content of a transaction with a user; an interface configured to output the transaction data generated by the transaction data generation portion to an automated transaction machine, and cause the automated transaction machine to execute the transaction with the user; and a telephone network communication portion configured to communicate with a host computer via a telephone network, and transmit an operational state of the automated transaction machine to the host computer, the operational state being obtained when the interface has output the transaction data to the automated transaction machine.

In addition, according to the present invention, an automated transaction system including: a communication terminal that is portable and connectable with a host computer, and an automated transaction machine that is connectable with the communication terminal. The communication terminal includes a transaction data generation portion configured to generate transaction data including a content of a transaction with a user, and an interface configured to output the transaction data generated by the transaction data generation portion to the automated transaction machine. The automated transaction machine includes a transaction data reception portion configured to receive the transaction data via the interface; a transaction execution portion configured to execute the transaction with the user on the basis of the transaction data received by the transaction data reception portion; and an operational state transmission portion configured to transmit an operational state of the transaction execution portion to the host computer via the communication terminal, the operational state being obtained when the transaction data reception portion has received the transaction data.

In addition, according to the present invention, a program causes a communication terminal to operate as: a transaction data generation portion configured to generate transaction data including a content of a transaction with a user; an interface configured to output the transaction data generated by the transaction data generation portion to an automated transaction machine, and cause the automated transaction machine to execute the transaction with the user; and a telephone network communication portion configured to communicate with a host computer via a telephone network, and transmit an operational state of the automated transaction machine to the host computer, the operational state being obtained when the interface has output the transaction data to the automated transaction machine.

### BRIEF DESCRIPTION OF DRAWINGS

FIG. 1 is a block diagram illustrating a configuration of an automated transaction system according to a first embodiment.

FIG. 2 is a schematic perspective view of an automated transaction machine according to the first embodiment.

FIG. 3 is a flowchart illustrating a transaction process workflow in the automated transaction system according to the first embodiment.

FIG. 4A is a diagram illustrating a display example of a transaction content output to a communication terminal according to the first embodiment.

FIG. 4B is a diagram illustrating a display example of a transaction content output to the communication terminal according to the first embodiment.

FIG. 4C is a diagram illustrating a display example of a transaction content output to the communication terminal according to the first embodiment.

FIG. 5 is a diagram illustrating a display example of transaction data output to the communication terminal according to the first embodiment.

FIG. 6 is a flowchart illustrating a transaction process workflow in the automated transaction system according to the first embodiment.

FIG. 7 is a flowchart illustrating a transaction process workflow in the automated transaction system according to the first embodiment.

FIG. 8 is a block diagram illustrating a configuration of an automated transaction system according to a second embodiment.

FIG. 9 is a flowchart illustrating a transaction process workflow in the automated transaction system according to the second embodiment.

FIG. 10 is a diagram illustrating a display example of an operational state of the automated transaction machine for a communication terminal according to the second embodiment.

FIG. 11 is a flowchart illustrating a transaction process workflow in the automated transaction system according to the second embodiment.

FIG. 12 is a system configuration diagram including an internet banking system of an automated cash transaction system according to a third embodiment.

FIG. 13 is an explanatory diagram illustrating a process workflow performed when a cash withdrawal process is executed by a smartphone and a monitor-less ATM in internet banking according to the third embodiment.

FIG. 14 is an explanatory diagram illustrating an example of a menu operation selection screen on the smartphone according to the third embodiment.

FIG. 15 is an explanatory diagram illustrating an example of a menu transaction selection screen on the smartphone according to the third embodiment.

FIG. 16 is an explanatory diagram illustrating an example of a menu money amount selection screen on the smartphone according to the third embodiment.

FIG. 17 is an explanatory diagram illustrating an example of a screen on the smartphone indicating that communication is being performed according to the third embodiment.

FIG. 18 is an explanatory diagram illustrating an example of a transaction registration screen including a two-dimensional code on the smartphone according to the third embodiment.

FIG. 19 is an explanatory diagram illustrating a process workflow performed when a cash withdrawal process is executed by a smartphone and a monitor-less ATM in internet banking according to a modification of the third embodiment.

FIG. 20 is an explanatory diagram illustrating an example of a menu operation selection screen on a smartphone according to a fourth embodiment.

FIG. 21 is an explanatory diagram illustrating a menu transaction result registration screen according to the fourth embodiment.

FIG. 22 is an explanatory diagram illustrating a process workflow performed when a cash withdrawal process is executed by the smartphone and a monitor-less ATM in internet banking according to the fourth embodiment.

### DESCRIPTION OF EMBODIMENTS

Next, details of the embodiments of the present invention will be described. Note that, the present invention is not limited to the following embodiments.

### First Embodiment

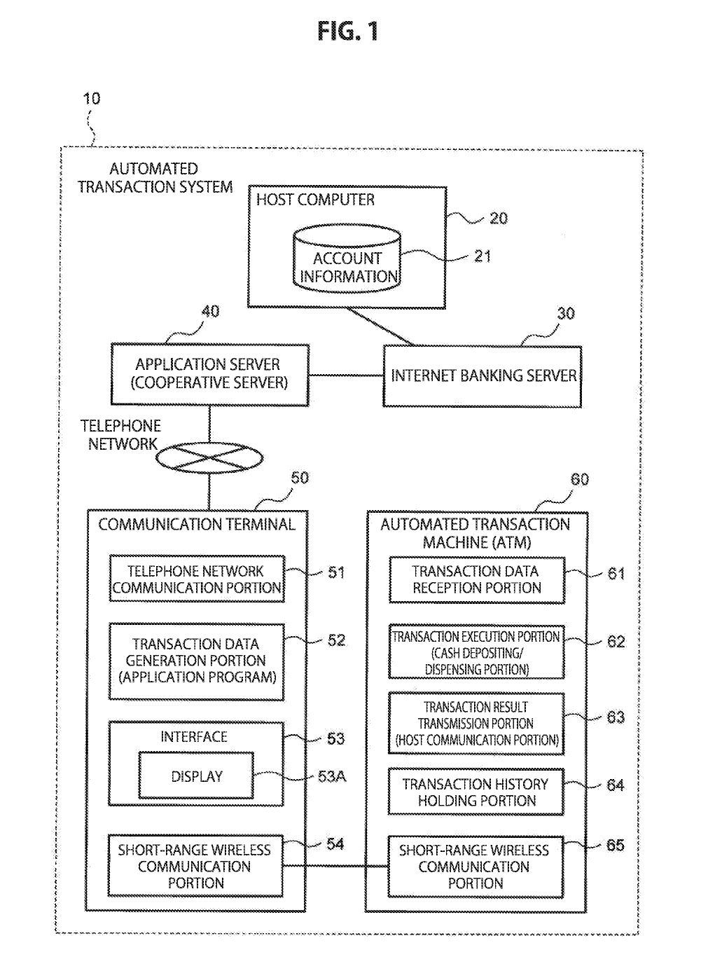

FIG. 1 is a block diagram illustrating a configuration of an automated transaction system 10 according to a first embodiment. The automated transaction system 10 includes a host computer 20 that stores information related to accounts of customers, an internet banking server 30 that provides internet banking, and an application server 40 that cooperates with the host computer 20 and the internet banking server 30 and provides a transaction application to users. In this embodiment, the host computer 20 includes an account information storage portion 21 that stores account information of the customers as a database.

According to this embodiment, the host computer 20 connects with the internet banking server 30, and the internet banking server 30 connects with the application server 40. Note that, hereinafter, sometimes the application server 40 may be referred to as a cooperative server.

In addition, the automated transaction system 10 includes a communication terminal 50 that may connect with the host computer 20 via a telephone network, and an automated transaction machine 60 that connects with the communication terminal 50 and performs a transaction with at least one user. In this embodiment, the communication terminal 50 is a portable communication terminal such as a smartphone or a tablet. In addition, in this embodiment, the automated transaction machine 60 is an automated/automatic teller machine (ATM).

In this embodiment, the communication terminal 50 includes a telephone network communication portion 51 that connects with the application server 40 via the telephone network and communicates with the host computer 20. In addition, the communication terminal 50 includes a transaction data generation portion 52 that cooperates with the application server 40 and generates transaction data including a content of a transaction between a user and the automated transaction machine 60. The transaction data generation portion 52 is an application program that decides (selects) a transaction content on the basis of information from the application server 40, for example, and generates transaction data indicating information of the decided transaction. The transaction data generated by the transaction data generation portion 52 is stored in the application server 40 and supplied to the automated transaction machine 60.

In addition, the communication terminal 50 includes an interface 53 that is an interface with a user. For example, the interface 53 includes a touchscreen display 53A that receives operation input by the user and displays a transaction content, a transaction situation, transaction data, or the like. In addition, the communication terminal 50 includes a short-range wireless communication portion (non-contact communication portion) 54 including a communication module that supports near-field communication (NFC) (registered trademark), Bluetooth (registered trademark), or the like.

The automated transaction machine 60 includes a transaction data reception portion 61 that receives transaction data generated by the transaction data generation portion 52 of the communication terminal 50, and a transaction execution portion 62 that executes a transaction with a user on the basis of the transaction data received by the transaction data reception portion 61. In this embodiment, the transaction execution portion 62 is a cash depositing/dispensing portion through which banknotes and coins are deposited/dispensed.

For example, the transaction data generation portion 52 of the communication terminal 50 generates a two-dimensional code such as a QR code (registered trademark) as the transaction data. Subsequently, the display 53A displays the generated QR code (registered trademark). In this case, the transaction data reception portion 61 of the automated transaction machine 60 is a QR code (registered trademark) reader (reader portion). Therefore, in this embodiment, the interface 53 functions as a user interface, and also functions as an interface for outputting transaction data generated by the transaction data generation portion 52 to the automated transaction machine 60.

In addition, the automated transaction machine 60 includes a transaction result transmission portion 63 and a transaction history holding portion 64. The transaction result transmission portion 63 transmits a result of a transaction with at least one user executed by the transaction execution portion 62 to the host computer 20 via the communication terminal 50. The transaction history holding portion 64 holds the result as a transaction history. The transaction result transmission portion 63 transmits information to the communication terminal 50 on the basis of information of the transaction data generated by the transaction data generation portion 52. The information transmitted to the communication terminal 50 includes whether the transaction is actually executed, whether the transaction is completed normally, and the like. The communication terminal 50 transmits the transaction result to the host computer 20.

More specifically, the automated transaction machine 60 includes a short-range wireless communication portion 65 that communicates with the short-range wireless communication portion 54 of the communication terminal 50 through short-range wireless communication. A result of the transaction executed by the automated transaction machine 60 is first transmitted to the communication terminal 50 through the short-range wireless communication. The communication terminal 50 receives the transaction result. Next, the communication terminal 50 transmits the transaction result to the host computer 20 through a telephone network by using the telephone network communication portion 51. In other words, the transaction result transmission portion 63 of the automated transaction machine 60 causes the communication terminal 50 to transmit the transaction result to the host computer 20.

Note that, the automated transaction machine 60 receives transaction data not only from the communication terminal 50 but also from at least one communication terminal that may connect with the host computer 20, and performs a transaction with at least one user who is a user of each of the at least one communication terminal. The transaction result transmission portion 63 transmits a result of a transaction with at least one user executed by the transaction execution portion 62 to the host computer 20 via a communication terminal that has connected with the host computer 20 and whose transaction data has been received by the transaction data reception portion 61 (in other words, the communication terminal of a user who is performing a transaction with the automated transaction machine 60. Hereinafter, such a communication terminal is referred to as the communication terminal 50).

The transaction history holding portion 64 holds results of past transactions executed by the transaction execution portion 62, as transaction histories. In this embodiment, the transaction history holding portion 64 holds a transaction result as a transaction history in the case where the transaction result transmission portion 63 has failed to transmit the transaction result. Specifically, the transaction result transmission portion 63 deletes a transaction result in the case where transmission of the transaction result is completed, but the transaction result transmission portion 63 transmits the transaction result to the transaction history holding portion 64 in the case where the transmission has failed. Therefore, in this embodiment, the transaction history holding portion 64 holds only transaction results (transaction contents) that has not been transmitted to the host computer 20.

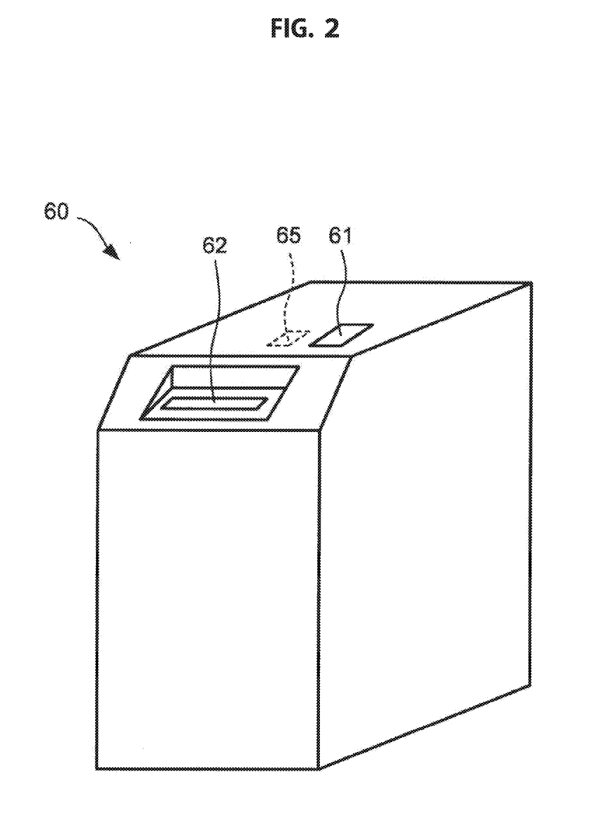

FIG. 2 is a schematic perspective view of the automated transaction machine 60. The automated transaction machine 60 includes the transaction data reception portion 61 and the transaction execution portion 62 as user interfaces. For example, the automated transaction machine 60 includes a QR code (registered trademark) reader as the transaction data reception portion 61, and includes a banknote input/output portion as the transaction execution portion 62. In addition, the short-range wireless communication portion 65 is provided near an upper surface of the automated transaction machine 60. For example, the short-range wireless communication portion 64 is a Bluetooth (registered trademark) wireless communication module. Note that, although not illustrated in the drawings, the automated transaction machine 60 includes a banknote storage portion, a counter, various kinds of sensors, and the like.

As illustrated in FIG. 2, in this embodiment, the automated transaction machine 60 does not include a user input operation portion, a transaction content/transaction result output portion, or an internet connection portion. The automated transaction machine 60 is a monitor-less machine that does not include a touchscreen display, for example, and is an offline machine that does not include a communication function with the host computer 20. Specifically, the automated transaction machine 60 may connect with the communication terminal 50 (host computer 20) through the short-range wireless communication alone. In addition, the transaction result transmission portion 63 of the automated transaction machine 60 functions as a host communication portion that communicates with the host computer 20 via the communication terminal 50 alone.

In other words, the transaction execution portion 62 of the automated transaction machine 60 executes a transaction with a user by using only transaction data received by the transaction data reception portion 61. In addition, the transaction result transmission portion 63 transmits a result of a transaction with at least one user who uses the automated transaction machine 60 via the short-range wireless communication portion 63 alone, to the host computer 20.

For example, since the internet communication function and the display serving as a user interface are omitted from the automated transaction machine 60, the automated transaction machine 60 becomes smaller and cost thereof is reduced drastically. In addition, for example, it is not necessary to install a cable for connecting the automated transaction machine 60 with the Internet. Therefore, it is easy to move the automated transaction machine 60.

In addition, since preparations for a transaction are made by using the communication terminal 50, for example, it is not necessary to decide or select a transaction content in front of the automated transaction machine 60. In addition, since the automated transaction machine 60 does not have a display, for example, there is no possibility that another person steals a glance at operation of the machine. This enables securing high safety. In this specification, sometimes the automated transaction machine 60 having the above-described configuration is referred to as a monitor-less ATM.

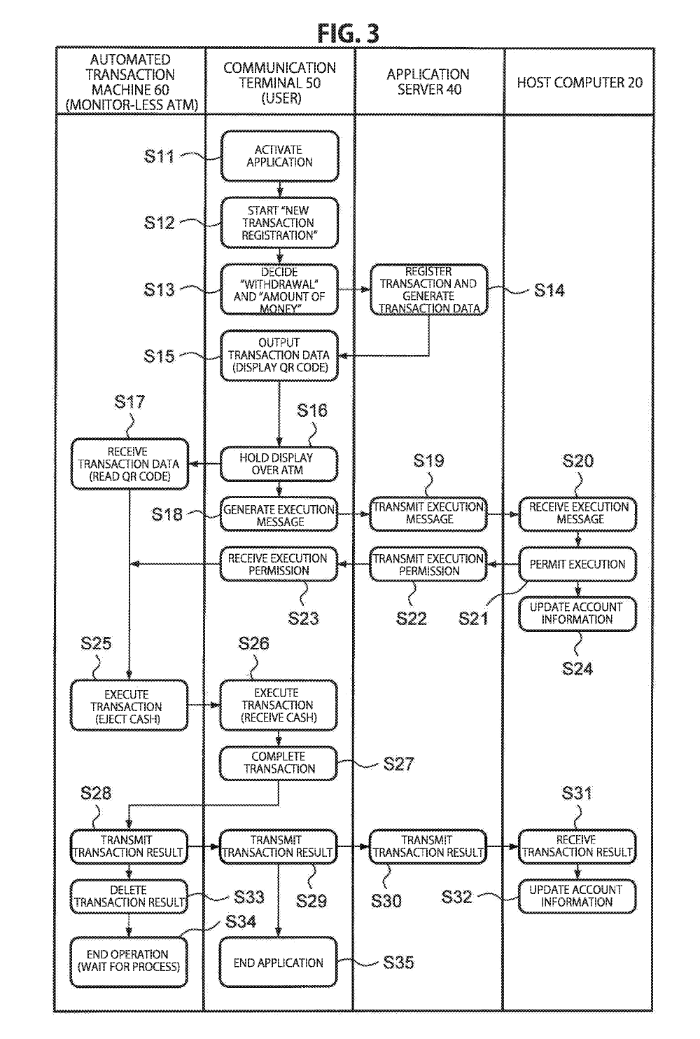

FIG. 3 is a flowchart illustrating an example of a transaction process workflow in the automated transaction system 10. Note that, the host computer 20 and the internet banking server 30 operate similarly. Therefore, FIG. 3 illustrates operation workflows of the host computer 20 and the internet banking server 30 as operation of the host computer 20. First, in this embodiment, the automated transaction system 10 starts its operation when a user operates the communication terminal 50 and activates a transaction application program.

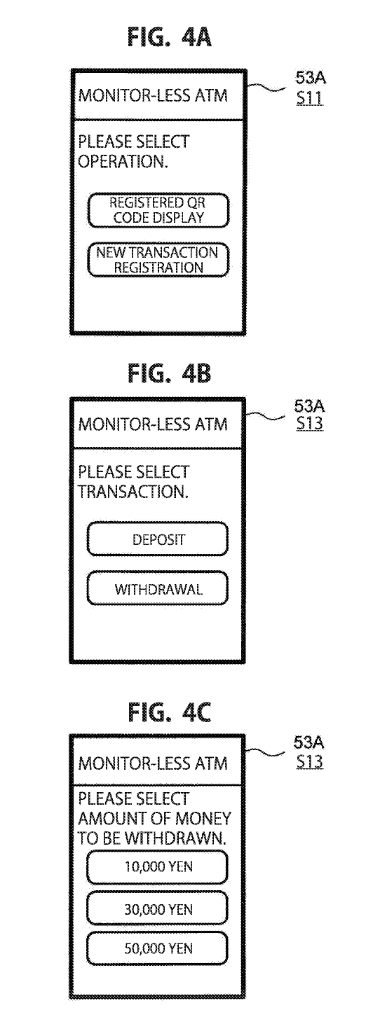

The user activates the application (Step S11), and selects or decides a desired transaction. Hereinafter, a case of newly withdrawing cash will be described as a transaction example. Specifically, first, when the application is activated and the user is authenticated, the display 53A of the communication terminal 50 displays a transaction selection screen. FIG. 4A is a diagram illustrating a display example of the display 53A immediately after the activation of the application (Step S11). The user taps an area of “NEW TRANSACTION REGISTRATION” displayed in the display 53A as illustrated in FIG. 4A, and starts registration of a new transaction (Step S12).

The transaction data generation portion 52 (application program) of the communication terminal 50 cooperates with the application server 40, and operates to newly generate transaction data. The transaction data generation portion 52 causes the display 53A to display (output) a screen for selecting (deciding) a specific transaction content. In this embodiment, the user decides to withdraw cash and decide an amount of money to be withdrawn. The transaction data generation portion 52 receives the decision (Step S13).

Specifically, as illustrated in FIG. 4B, the transaction data generation portion 52 first controls the display 53A such that the display 53A displays a transaction selection screen. When the user taps an area of “WITHDRAWAL”, the transaction data generation portion 52 receives selection of cash withdrawal. Next, as illustrated in FIG. 4C, the transaction data generation portion 52 causes the display 53A to display a screen for deciding the amount of money to be withdrawn. For example, when the user taps an area of “30,000 YEN”, the transaction data generation portion 52 decides to generate transaction data indicating a transaction content for dispensing 30,000 yen.

Next, the transaction data generation portion 52 transmits information indicating the transaction content to the application server 40, and the application server 40 newly registers the transaction. In addition, the transaction data generation portion 52 cooperates with the application server 40 and generates transaction data including the transaction content (Step S14).

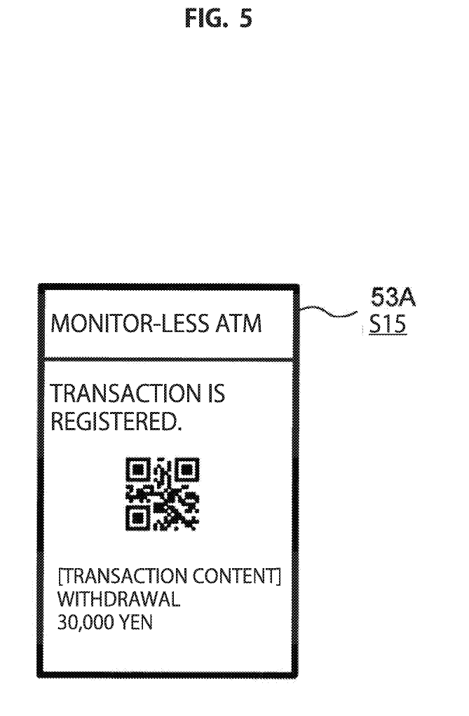

Next, the transaction data generation portion 52 outputs the generated transaction data. In this embodiment, the transaction data generation portion 52 generates a QR code (registered trademark) by coding the transaction data, and displays the generated QR code (registered trademark) on the display 53A (Step S15). FIG. 5 is a diagram illustrating a screen display example including the QR code (registered trademark) displayed on the display 53A.

Next, the user sends the transaction data generated by the transaction data generation portion 52 to the automated transaction machine 60. Specifically, the user holds the display 53A displaying the QR code (registered trademark), over the QR code (registered trademark) reader serving as the transaction data reception portion 61 (Step S16). Accordingly, the transaction data reception portion 61 reads the QR code (registered trademark) and receives the transaction data (Step S17). On the other hand, the transaction data generation portion 52 of the communication terminal 50 generates an execution message based on the transaction data, and transmits the generated execution message to the application server 40 (Step S18).

The application server 40 transmits the received execution message to the host computer 20 (Step S19), and the host computer 20 receives the execution message (Step S20). The host computer 20 permits execution of the transaction on the basis of the execution message, and transmits the execution permission information to the application server 40 (Step S21). The application server 40 receives the execution permission information, and then transmits the execution permission information to the communication terminal 50 (Step S22). In this embodiment, the communication terminal 50 receives the execution permission information (Step S23), and the transaction execution portion 62 of the automated transaction machine 60 receives the execution permission and executes the transaction (Step S25). In this embodiment, the cash depositing/dispensing portion serving as the transaction execution portion 62 counts and ejects cash.

The user receives the cash ejected from the transaction execution portion 62 (cash depositing/dispensing portion) of the automated transaction machine 60 (Step S26), and completes the transaction (Step S27). In addition, after permitting the execution, the host computer 20 updates account information in the account information storage portion 21 (Step S24).

Next, the transaction result transmission portion 63 of the automated transaction machine 60 transmits information indicating the result of the transaction with the user to the communication terminal 50 (Step S28), and the communication terminal 50 transmits the received transaction result to the application server 40 via the telephone network (Step S29). The application server 40 transmits the received transaction result to the host computer 20 (Step S30). The host computer 20 receives the transaction result from the communication terminal 50 (Step S31), and updates the account information in the account information storage portion 21 (Step S32).

After transmission of the transaction result, the transaction result transmission portion 63 of the automated transaction machine 60 deletes the information indicating the transaction result (Step S33), and ends the operation (Step S34). Then, the automated transaction machine 60 waits until new transaction data is received.

In addition, after transmission of the transaction result to the host computer 20, the communication terminal 50 ends the process, and the user ends the application (Step S35). Then, the communication terminal 50 waits until the user activates the application.

Note that, even in the case where the execution message is received, the host computer 20 does not permit the execution when the received transaction data is illegally generated or when a duplicated QR code (registered trademark) is read, for example. Therefore, in such cases, the transaction execution portion 62 of the automated transaction machine 60 does not execute the transaction. In addition, the host computer 20 stores the fact that the illegally generated transaction data is received.

As described above, the automated transaction machine 60 according to this embodiment includes the transaction data reception portion 61, the transaction execution portion 62, and the transaction result transmission portion 63. The transaction data reception portion 61 receives transaction data generated by the communication terminal 50 that may connect with the host computer 20, the transaction data including a content of a transaction with a user of the communication terminal 50. The transaction execution portion 62 executes the transaction with the user on the basis of the transaction data received by the transaction data reception portion 61. The transaction result transmission portion 63 transmits a result of the transaction executed by the transaction execution portion 62 to the host computer via the communication terminal 50.

Therefore, the communication terminal 50 transmits, to the host computer 20, information indicating whether or not the transaction with the user is actually executed or information indicating whether or not the transaction is executed normally, even in the case where the automated transaction machine 60 does not have the communication function, or even in the case where the communication function is temporarily lost, for example. Therefore, it is possible to provide the automated transaction machine 60 whose situations and results of transactions with users can always be recognized by the host computer 20 side. In addition, in the case where the automated transaction machine 60 is the monitor-less ATM, it is possible to provide the automated transaction machine 60 and the system 10 with high safety at low cost.

In addition, the communication terminal 50 includes the transaction data generation portion 52, the interface 53, and the telephone network communication portion 51. The transaction data generation portion 52 generates transaction data including a content of a transaction with a user. The interface 53 outputs the transaction data generated by the transaction data generation portion 52 to the automated transaction machine 60, and causes the automated transaction machine 60 to execute the transaction with the user. The telephone network communication portion 51 communicates with the host computer 20 via the telephone network, and transmits a result of the transaction between the user and the automated transaction machine 60 executed based on the transaction data, to the host computer 20. Therefore, it is possible to provide the communication terminal 50 whose situations and results of transactions with a user can always be recognized by the host computer 20 side with high safety.

Note that, instead of the communication terminal 50, it is possible to cause a communication terminal to function as the communication terminal 50 as long as a program (application program) for causing the communication terminal to function as the transaction data generation portion 52 is installed in the communication terminal, even in the case where the communication terminal includes a general communication function such as a telephone network communication function or a short-range wireless communication function and an interface such as a display. Therefore, according to this embodiment, it is also possible to provide a program that is to be installed in a communication terminal and causes the communication terminal to function as the transaction data generation portion 52 and causes the communication terminal to function as the interface 53 and the telephone network communication portion 51.

In addition, the automated transaction system 10 including them (such as the communication terminal 50 and the automated transaction machine 60) has high safety at low cost. In the automated transaction system 10, it is possible for the host computer 20 side to always recognize situations and results of transactions with users.

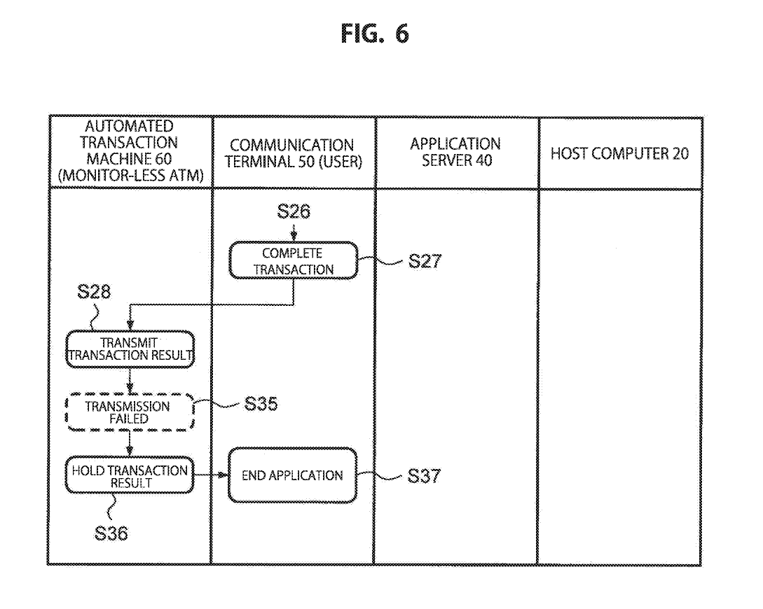

FIG. 6 is a flowchart illustrating an operation workflow performed in the case where the automated transaction machine 60 fails to transmit a transaction result in the automated transaction system 10. For example, in the case where the communication terminal 50 is moved to a position outside a short-range wireless communication region of the automated transaction machine 60 after a user receives cash (Step S26 in FIG. 3), the transaction result transmission portion 63 of the automated transaction machine 60 cannot communicate with the communication terminal 50.

In this case, as illustrated in FIG. 6, it is determined that the transaction result transmission portion 63 has tried to transmit the transaction result (Step S28) but failed to transmit the transaction result (Step S35). The transaction result transmission portion 63 transmits information of the transaction result failed to be transmitted, to the transaction history holding portion 64. The transaction history holding portion 64 holds the transaction result as a transaction history (Step S36). Note that, in this embodiment, the communication terminal 50 ends the application in the case where a transaction result is not received for a predetermined period of time, for example (Step S37).

As described above, the automated transaction system 64 includes the transaction history holding portion 64 that holds a result of a transaction as a transaction history in the case where the transaction result transmission portion 63 has failed to transmit the result of the transaction. Therefore, even in the case where a result of a transaction has failed to be transmitted at the time of the transaction, it is possible to hold and transmit the result of the finished transaction again when a next or subsequent transaction is executed. Therefore, it is possible for the host computer 20 to recognize results of transactions certainly.

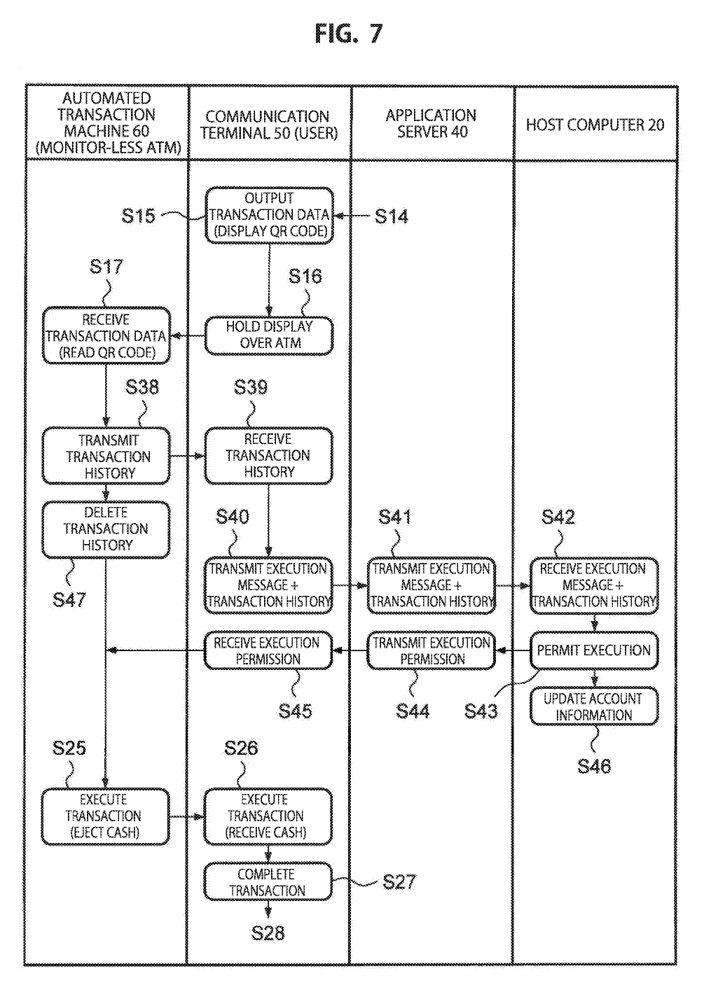

FIG. 7 is a flowchart illustrating an operation workflow performed in the case where the transaction history holding portion 64 of the automated transaction machine 60 holds a transaction history in the automated transaction system 10. For example, the transaction history holding portion 64 holds a past transaction result as a transaction history in the case where the automated transaction machine 60 has executed transaction operation by using the communication terminal 50 or another communication terminal in the past but the transaction result transmission portion 63 of the automated transaction machine 60 has failed to transmit the transmission result at that time.

In this case, the transaction result transmission portion 63 transmits the transaction history held by the transaction history holding portion 64 to the communication terminal 50 (Step S38) after the communication terminal 50 outputs transaction data (to be used in current transaction) to the transaction data reception portion 51 of the automated transaction machine 60 and the transaction data reception portion 51 receives the transaction data (immediately after Step S17 in this embodiment). In the case where the transaction history is received (Step S39), the communication terminal 50 also transmits the transaction history to the application server 40 (Step S40) when generating and transmitting an execution message (Step S18 in FIG. 3).

The application server 40 transmits the execution message and the transaction history to the host computer 20 (Step S41), and the host computer 20 receives the execution message and the transaction history (Step S42). The host computer 20 permits execution (Step S43), and transmits execution permission information to the application server 40 (Step S44). The communication terminal 50 receives the execution permission information (Step S45), and transmits it to the transaction execution portion 62 of the automated transaction machine 50. After the execution is permitted, the host computer reflects the past transaction result of the automated transaction machine 60 in account information on the basis of the received transaction history, and updates the account information of the customer (Step S46).

In this embodiment, the transaction history holding portion 64 deletes the transaction history (Step S47) after the transaction result transmission portion 63 transmits the transaction history (past transaction process result in the automated transaction machine 60). Next, the transaction execution portion 62 executes a usual transaction (proceeds to Step S25).

As described above, in the case where the transaction history holding portion 64 holds a transaction history, the transaction result transmission portion 63 transmits the transaction history to the host computer 20 via the communication terminal 50 when the transaction execution portion 62 executes the transaction. Therefore, for example, even in the case where the transaction result has failed to be transmitted, the transaction result transmission portion 63 transmits the past transaction result to the host computer 20 via the communication terminal 50 at the time of a next or subsequent transaction. This enables the host computer 20 to certainly recognize logs of transactions with the automated transaction machines 60 (such as the monitor-less ATMs).

In addition, the transaction result transmission portion 63 deletes information (log data) in the case where the information is transmitted by the transaction result transmission portion 63, the information indicating a transaction result of the transaction execution portion 62 including a transaction history held by the transaction history holding portion 64. In other words, the transaction result transmission portion 63 transmits the transaction history held by the transaction history holding portion 64 to the host computer 20, and deletes the transaction history after transmission of the transaction history. Accordingly, it is not necessary to install a large-capacity storage device in the automated transaction machine 60, and this enables lowering the cost.

As described above, in this embodiment, the automated transaction machine 60 includes the transaction result transmission portion 63 that transmits a result of a transaction with at least one user to the host computer 20 via a communication terminal (such as the communication terminal 50) whose transaction data has been received by the transaction data reception portion 61, the transaction with at least one user having been executed by the transaction execution portion.

In addition, the communication terminal 50 includes the telephone network communication portion 51 that communicates with the host computer 20 via the telephone network, and transmit a result of a transaction with at least one user of the automated transaction machine 60 to the host computer 20. The telephone network communication portion 51 relays transmission of results of transactions between a user and the automated transaction machines 60, to the host computer 20.

In addition, the user prepares for the transaction (generates the transaction data) by using the communication terminal 50, and then the automated transaction machine 60 executes the transaction with the user. Accordingly, for example, even in the case where the transaction is executed by using the low-cost, compact, and monitor-less ATM (automated transaction machine 60) that communicates with the communication terminal 50 through only the short-range wireless communication, it is possible to certainly reflect a result of the transaction in the host computer 20 and improve stability and safety of the transaction.

### Second Embodiment

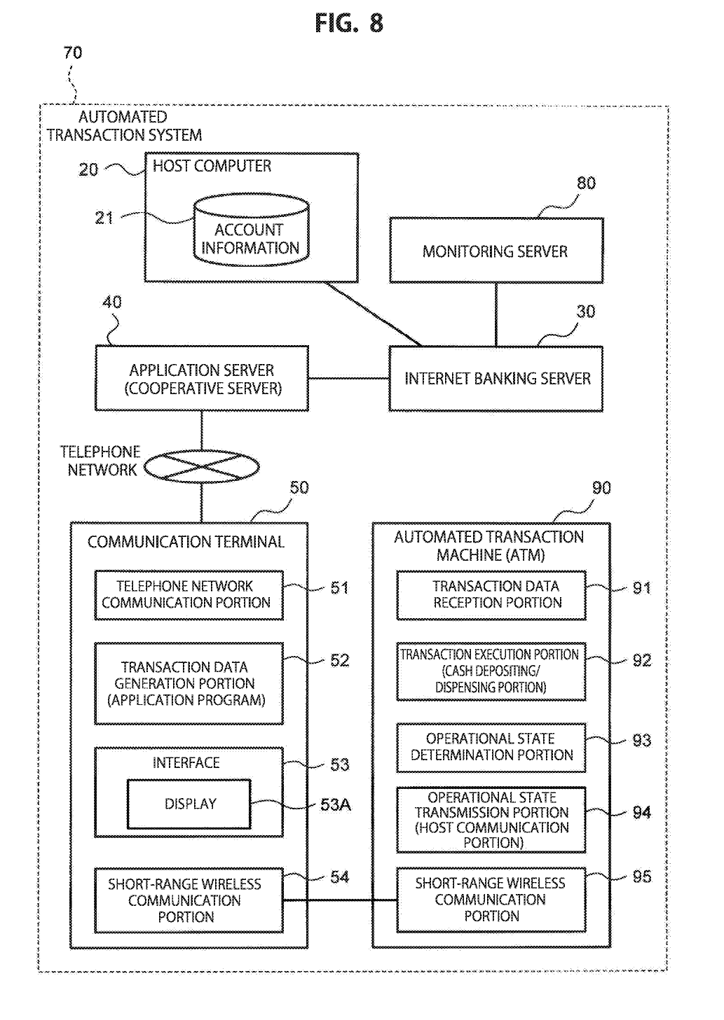

FIG. 8 is a block diagram illustrating a configuration of an automated transaction system 70 according to the second embodiment. The automated transaction system 70 has a configuration similar to the automated transaction system 10 except that the automated transaction system 70 includes a monitoring server 80 and an automated transaction machine 90. In this embodiment, the automated transaction system 70 includes the automated transaction machine 90 instead of the automated transaction machine 60. In addition, the automated transaction system 70 includes the monitoring server 80 that monitors operational states of the automated transaction machine 90.

First, in this embodiment, the automated transaction machine 90 includes a transaction data reception portion 91 and a transaction execution portion 92 that are similar to the transaction data reception portion 61 and the transaction execution portion 62 of the automated transaction machine 60, respectively. In addition, the automated transaction machine 90 includes an operational state determination portion 93 and an operational state transmission portion 94. The operational state determination portion 93 determines an operational state of the transaction execution portion 92. The operational state transmission portion 94 transmits the operational state of the transaction execution portion 92 obtained when the transaction data reception portion 91 receives transaction data from the communication terminal 50, to the host computer 20 and the monitoring server 80 via the communication terminal 50.

In this embodiment, a case where the automated transaction machine 90 is a monitor-less ATM such as the automated transaction machine 60 will be described. In other words, the automated transaction machine 90 does not include a display used by a user for inputting operation or used for displaying information, for example. Therefore, the transaction execution portion 92 executes a transaction with a user by using only transaction data received by the transaction data reception portion 91.

In addition, the automated transaction machine 90 includes a short-range wireless communication portion 95 that establishes short-range wireless communication with the communication terminal 50. In addition, in a way similar to the automated transaction machine 60, the automated transaction machine 90 connects only with the communication terminal 50 through the short-range wireless communication, and does not have any other communication function. Accordingly, the operational state transmission portion 94 functions as a host communication portion that communicates with the host computer 20 via the communication terminal 50 alone. The operational state transmission portion 94 transmits the operational state of the transaction execution portion 92 to the host computer 20 and the monitoring server 80 via the short-range wireless communication portion 95 alone. The operational state of the transaction execution portion 92 is obtained when the transaction data reception portion 91 has received transaction data.

The operational state determination portion 93 determines whether or not the transaction execution portion 92 is in a normal state (in other words, whether or not the automated transaction machine 90 is in a state capable of executing a transaction) on the basis of information obtained from various kinds of sensors (not illustrated) or the like installed in the automated transaction machine 90. For example, the operational state determination portion 93 determines that the transaction execution portion 92 is in a state incapable of dispensing cash in the case where no cash is stored in the transaction execution portion 92. Alternatively, the operational state determination portion 93 determines that the transaction execution portion 92 is in a state incapable of depositing cash in the case where the maximum amount of cash is stored in the transaction execution portion 92.

In addition, for example, the operational state determination portion 93 determines that the transaction execution portion 92 (automated transaction machine 90) is not in a handleable state in the case where the transaction data reception portion 91 receives transaction data for a cash dispensing transaction while the transaction execution portion 92 is determined to be in a state incapable of dispensing cash.

The operational state transmission portion 94 transmits an operational state of the automated transaction machine 90 to the host computer 20 and the monitoring server 80 by using the telephone network communication portion 51 of the communication terminal 50. Specifically, the operational state transmission portion 94 transmits the operational state of the transaction execution portion 92 to the communication terminal 50 via the short-range wireless communication portion 95, and the communication terminal 50 transmits it to the host computer 20 and the monitoring server 80 via the telephone network communication portion 51.

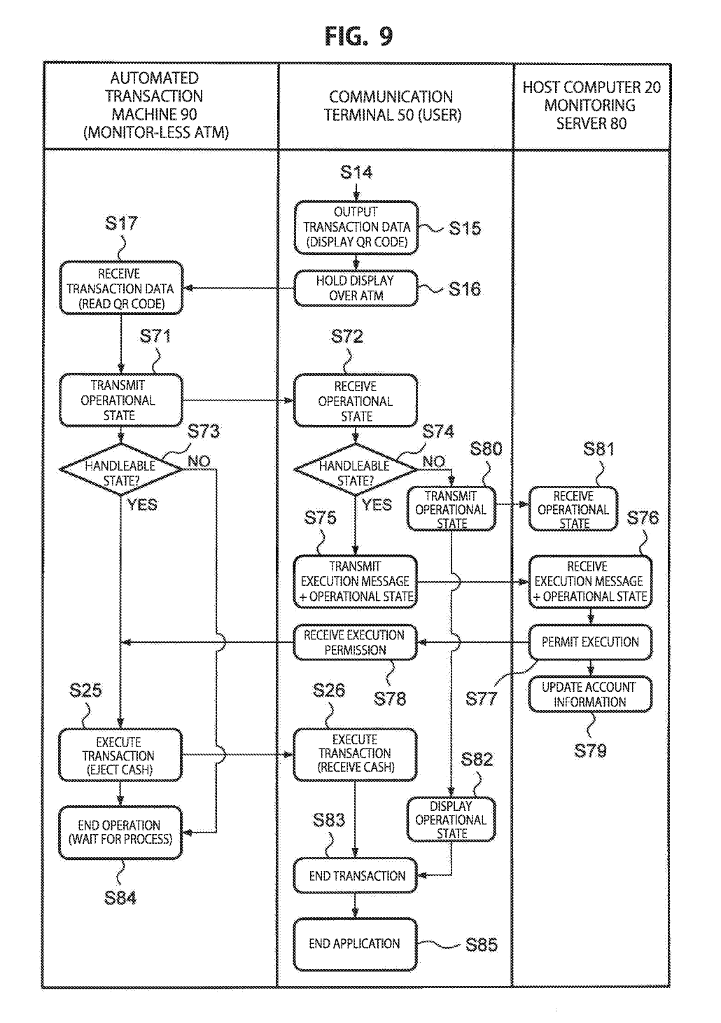

FIG. 9 is a flowchart illustrating an example of a transaction process workflow in the automated transaction system 70. Note that, in FIG. 9, illustrations of the process workflow of the application server 40 are omitted. In addition, illustrations of Steps S11 to S14 of the communication terminal 50 are omitted. First, the automated transaction system 70 performs processes similar to the automated transaction system 10 until the transaction data reception portion 91 of the automated transaction machine 90 receives transaction data (Step S17).

After the transaction data reception portion 91 receives the transaction data, the operational state transmission portion 94 of the automated transaction machine 90 transmits an operational state of the transaction execution portion 92 to the communication terminal 50 (Step S71). Note that, in this embodiment, the operational state determination portion 93 always monitors states of the transaction execution portion 92 and determines its operational state. The operational state transmission portion 94 transmits the state of the transaction execution portion 92 obtained when the transaction data reception portion 91 has received the transaction data, to the communication terminal 50. The communication terminal 50 receives the operational state of the transaction execution portion 92 from the automated transaction machine 90 (Step S72).

The automated transaction machine 90 and the communication terminal 50 operate differently in accordance with whether or not the transaction execution portion 92 is in a handleable state (Step S73 and Step S74, respectively). First, in the case where the transaction execution portion 92 is in the handleable state (normal operational state), the communication terminal 50 transmits an execution message to the host computer 20 via the application server 40, and transmits the operational state of the transaction execution portion 92 to the monitoring server 80 (Step S75). The host computer 20 and the monitoring server 80 receive the execution message and the operational state of the transaction execution portion 92, respectively (Step S76).

The host computer 20 permits execution of the transaction on the basis of the received execution message of the transaction (Step S77), and transmits the permission to the communication terminal 50 via the application server 40. The communication terminal 50 receives execution permission information (Step S78), and transmits it to the automated transaction machine 90. On the other hand, the host computer 20 updates account information (Step S79). In addition, the monitoring server 80 updates the operational state of the transaction execution portion 92 (automated transaction machine 90).

In the case where the transaction execution portion 92 is in the handleable state, the transaction execution portion 92 of the automated transaction machine 90 executes a transaction with a user on the basis of the transaction data received by the transaction data reception portion 91 (Step S25), and ends the operation (Step S84). The user receives cash, for example (Step S26), and ends the transaction with the automated transaction machine 90 (Step S83).

On the other hand, in the case where the transaction execution portion 92 is not in the normal operational state (is in an abnormal state), the transaction execution portion 92 does not execute the transaction and ends the operation (Step S84). In addition, in the case where the communication terminal 50 receives operational state information indicating that the transaction execution portion 92 is not in the normal operational state, the communication terminal 50 transmits the operational state information to the host computer 20 and the monitoring server 80 (Step S80). The host computer 20 and the monitoring server 80 receive the operational state information (Step S81), and update account information and monitoring information.

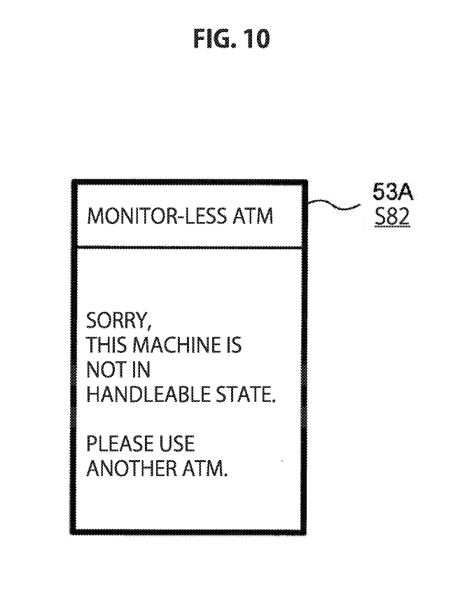

In addition, an application program serving as the transaction data generation portion 52 of the communication terminal 50 causes the display 53A to display the operational state information of the transaction execution portion 92 indicating that it is impossible to execute the transaction (Step S82). FIG. 10 is a diagram illustrating a display example of the display 53A in the case where the transaction execution portion 92 is not in the normal operational state. As illustrated in FIG. 10, the display 53A displays an operational state of the automated transaction machine 90 obtained when the automated transaction machine 90 has received transaction data. After the operational state information is displayed, the communication terminal 50 ends the transaction (Step S83) and ends the application (Step S85).

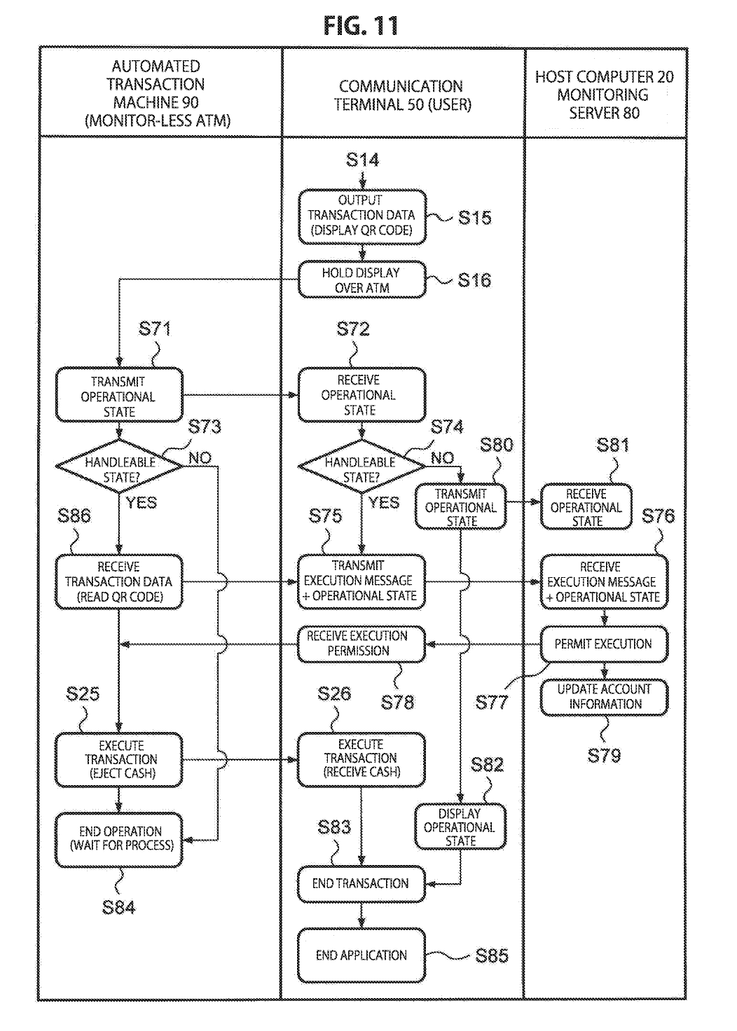

FIG. 11 is a flowchart illustrating another process workflow example of the automated transaction system 70. As illustrated in FIG. 11, the automated transaction machine 90 may transmit its operational state immediately after the communication terminal 50 enters a communication area of the automated transaction machine 90 (for example, the communication terminal 50 is held over the automated transaction machine 90) and the short-range wireless communication is established. In other words, after transmitting the operational state (Step S71), the automated transaction machine 90 may perform a transaction data reception process (such as a QR code (registered trademark) reading process) in accordance with the operational state (Step S86).

As described above, the automated transaction machine 90 according to this embodiment includes the transaction data reception portion 91, the transaction execution portion 92, and the operational state transmission portion 94. The transaction data reception portion 91 receives transaction data generated by the communication terminal 50 connecting with the host computer 20, the transaction data including a content of a transaction with a user of the communication terminal 50. The transaction execution portion 92 executes the transaction with the user on the basis of the transaction data received by the transaction data reception portion 91. The operational state transmission portion 94 transmits the operational state of the transaction execution portion 92 obtained when the transaction data reception portion 91 has received the transaction data, to the host computer 20 via the communication terminal 50.

Therefore, for example, the communication terminal 50 transmits, to the host computer 20, the operational state of the transaction execution portion 92 (in other words, information indicating whether or not the automated transaction machine 90 is in the state capable of executing a transaction) even in the case where the automated transaction machine 90 does not have a communication function or even in the case where an installed communication function is temporarily lost. Therefore, it is possible to provide the automated transaction machine 90 whose operational state can always be recognized by the host computer 20 side. In addition, in the case where the automated transaction machine 90 is the monitor-less ATM, it is possible to provide the automated transaction machine 90 and the system 70 with high safety at low cost.

In addition, the communication terminal 50 includes the transaction data generation portion 52, the interface 53, and the telephone network communication portion 51. The transaction data generation portion 52 generates transaction data including a content of a transaction with a user. The interface 53 outputs the transaction data generated by the transaction data generation portion 52 to the automated transaction machine 90, and causes the automated transaction machine 90 to execute the transaction with the user. The telephone network communication portion 51 communicates with the host computer 20 via the telephone network, and transmits, to the host computer 20, the operational state of the automated transaction machine 90 obtained when the interface 53 has output the transaction data to the automated transaction machine 90. The telephone network communication portion 51 relays transmission of the operational state performed by the automated transaction machine 90, to the host computer 20.

Therefore, it is possible to provide the communication terminal 50 that enables transactions between a user and the automated transaction machines 90 with high safety, and enables the host computer 20 side to always recognize the operational states of the automated transaction machines 90.

Note that, instead of the communication terminal 50, it is possible to cause a general communication terminal to function as the communication terminal 50 as long as a program (application program) for causing the general communication terminal to function as the transaction data generation portion 52 is installed in the general communication terminal, the general communication terminal including a communication function such as a telephone network communication function or a short-range wireless communication function and an interface such as a display. Therefore, according to this embodiment, it is also possible to provide a program that is to be installed in a communication terminal and causes the communication terminal to function as the transaction data generation portion 52 or causes the communication terminal to function as the interface 53 and the telephone network communication portion 51.

In addition, the automated transaction system 10 including them (such as the communication terminal 50 and the automated transaction machine 90) has high safety at low cost. In the automated transaction system 10, it is possible for the host computer 20 side to always recognize the operational state of the automated transaction machine 90.

Note that, it is possible to combine the first embodiment and the second embodiment. For example, the automated transaction machine 90 may include the transaction result transmission portion 63 and/or the transaction history holding portion 64. In this case, the communication terminal 50 transmits an execution result of a transaction with a user to the host computer 20 in addition to the operational state of the transaction machine. This enables the host computer 20 to recognize a larger amount of on-site information. In addition, the automated transaction system 70 may include the automated transaction machine 60. This enables suggesting usage of the automated transaction machine 60 to the communication terminal 50 in the case where the automated transaction machine 90 is in an inoperable state, for example.

In addition, the communication terminal 50 may include an internet communication portion (not illustrated) that may connect with the Internet such as a Wi-Fi (registered trademark) module in addition to the telephone network communication portion 51, such that the internet communication portion and the telephone network communication portion 51 are selectively operated. In other words, the communication terminal 50 may selectively connect with the telephone network or the Internet in accordance with radio field intensity, for example.

For example, in the case where the communication terminal 50 establishes communication with the Internet by using the internet communication portion, the internet communication portion communicates with the application server 40 (generates transaction data) and communicates with the host computer 20 (relays transmission of a result of a transaction with the automated transaction machine 60 transmission of an operational state from the automated transaction machine 90) instead of the telephone network communication portion 51.

In addition, in the above-described embodiments, the case where the automated transaction machines 60 and 90 are the monitor-less ATMs has been described. However, the configurations of the automated transaction systems 60 and 90 in the automated transaction systems 10 and 70 are not limited thereto. For example, each of the automated transaction machines 60 and 90 may include a communication function with the host computer 20 via the Internet or a touchscreen display as a user interface. For example, if the automated transaction machines 60 and 90 have a function of transmitting transaction results and operational states via the communication terminal 50 even in the case where the automated transaction machines 60 and 90 have communication functions other than the short-range wireless communication, it is possible to certainly transmit transaction results and states of machines to the host computer 20 and keep account information and machine operational states up to date when the communication function is blocked due to a disaster or the like.

Next, another embodiment will be described.

Automated transaction systems using automated cash transaction machines such as automated teller machines (ATMs) and cash dispensers (CDs) that are connected with financial institutions via dedicated lines, have been known.

For example, JP 2013-117849A discloses an automated transaction system that executes financial transactions via an ATM and a mobile phone. In this system, the ATM detects an ATM card inserted by a user, starts communication with a mobile phone of the user through a short-range wireless communication means such as Bluetooth (registered trademark), starts communication with a host computer of a financial institution via the mobile phone of the user at the time of a transaction process, and executes a financial transaction.

However, in the above-described conventional technology, it is necessary to monitor and recognize operation states of a wireless communication device embedded in the ATM. Accordingly, the above-described conventional technology includes problems that the wireless communication facility costs more than a wired communication facility and the cost for monitoring, maintaining, and operating the automated cash transaction system increases.

According to the following embodiment, there is provided a mobile communication terminal and an automated cash transaction system that are capable of reducing cost for the automated cash transaction system. According to the following embodiment, it is possible to achieve the automated cash transaction system capable of monitoring, maintaining, and operating the system at low cost.

### Third Embodiment

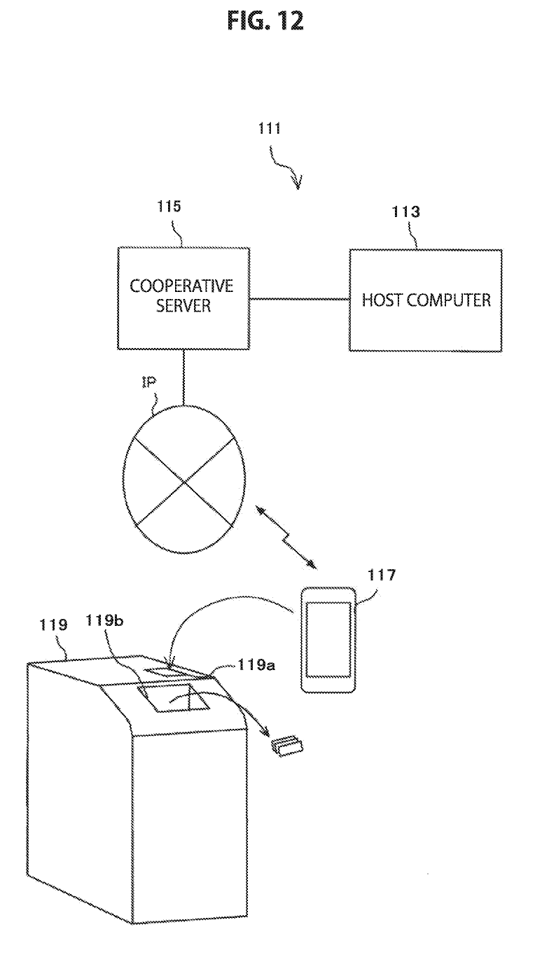

Online banking, internet banking, and internet banking service that are used through PCs in homes via the Internet, have been known. In addition, as the online banking, an automated transaction system (so-called mobile banking) has been known. The mobile banking uses a mobile communication terminal and executes financial transactions via a communication network (network) such as a mobile phone network or the Internet. FIG. 12 is a system configuration diagram including an internet banking system 111 of an automated cash transaction system according to this embodiment. The internet banking system 111 includes a host computer 113 for core banking that is installed in a financial institution, and a cooperative server 115 (online banking server) of internet banking (online banking) operated by the financial institution or the like connected with the host computer. In addition, a dedicated line or the like is included in a part or all of the communication network described above.

The automated cash transaction system according to this embodiment further includes a mobile communication terminal of a customer such as a smartphone 117, and a monitor-less ATM 119 that is a cash dispenser installed in a financial institution. The smartphone 117 connects with the internet banking system 111 via communication network IP of a mobile phone network, the Internet, or the like.

The host computer 113 has a function of managing account numbers, balances in the accounts, account histories, and the like for respective customers of the internet banking as account information in a database, and executing various transaction processes requested by customers.

Although not illustrated in the drawings, the host computer 113 is a computer device that uses RAM as primary storage working memory and controls entire operation including transaction processes in accordance with various software programs stored in a storage portion such as ROM or a hard disk drive. The host computer 113 reads out a control program in which process procedure for achieving various transaction execution functions is written from a storage medium such as ROM or RAM in which the control program is stored, and the host computer 113 interprets and executes the program. In addition, the host computer 113 includes a network connection portion (not illustrated). The network connection portion is a wired/wireless interface with the cooperative server 115 included in the system. The network connect portion transmits/receives various kinds of data. The host computer 113 stores a correspondence table in which the account numbers of the respective customers are associated with mobile communication terminal IDs that are identifiers of the smartphones 117 of the respective customers. The host computer 113 process a transaction reservation transmitted from the cooperative server 115, and processes a transaction permission of a customer of the internet banking.

The cooperative server 115 (web server) connects with the host computer 113 via a predetermined communication line. Although not illustrated in the drawings, the cooperative server 115 is also a computer device that uses RAM as primary storage working memory and controls entire operation including transaction processes in accordance with various software programs stored in a storage portion such as ROM or a hard disk drive, like the host computer 113.

The customer operates a web browser or a web app in a personal computer or the smartphone 117, accesses the cooperative server 115 that is an established web (World Wide Web) site via the communication network IP, and registers a customer ID and a password on the internet banking in advance. The cooperative server 115 has a function of authenticating the customer ID and the password of the customer, and then providing transactions with a financial institution such as bank transfer and checking of money balances, as services for the customer via the web browser.

Although not illustrated in the drawings, the smartphone 117 is a computer device including a communication portion including a transmission/reception antenna, a display portion including a touchscreen such as a liquid crystal display or the like that also serves as an input portion, a sound input portion including a microphone, a sound output portion including a speaker, a connection interface including a connector for connection with an external cable, and a control portion including a CPU, memory, various processing circuits, and the like. In accordance with programs (software) stored in the memory, the smartphone 117 functions as a register means for preliminarily registering a content of a cash transaction on a server or the like, a permission request means for requesting permission for the cash transaction from the server, and a display means for causing the display portion to display a code pattern of a two-dimensional code such as a QR code (registered trademark) representing the preliminarily registered content of the cash transaction while waiting for reception of the permission or after receiving the permission.

A unique mobile communication terminal IDs are set for the smartphones 117 of the respective customers. When the internet banking is used such as registration (reservation) of a transaction with the monitor-less ATM, the cooperative server 115 (host computer 113) is notified of the mobile communication terminal ID. Subsequently, the account name, the account number, or the like of the customer is authenticated and specified for identity verification, and then a transaction menu or the like is displayed on the smartphone 117.

A two-dimensional code reader portion 119a is provided on the monitor-less ATM 119. It is possible to place the smartphone 117 on the two-dimensional code reader portion 119a, and the two-dimensional code reader portion 119a reads an image of a two-dimensional code displayed on a display screen of the smartphone 117. The monitor-less ATM 119 includes a cash dispensing portion 119b that performs a cash dispensing process such as banknotes, for example. In this embodiment, the monitor-less ATM 119 is an offline device that does not connect with the communication network IP or the like. In other words, the monitor-less ATM 119 is an offline device that does not connect with any network. The monitor-less ATM 119 is an automated cash transaction machine that performs the cash dispensing process after the two-dimensional code reader portion 119a of the monitor-less ATM 119 reads the two-dimensional code displayed on the display screen of the smartphone 117 of the customer. The cash dispensing operation of the monitor-less ATM 119 using the smartphone 117 is performed via the two-dimensional code reader portion 119a. The monitor-less ATM 119 is a computer device including the cash dispensing portion 119b, the two-dimensional code reader portion 119a, and a control portion. The cash dispensing portion 119b includes a mechanism portion that classifies, counts, conveys, and ejects banknotes. The two-dimensional code reader portion 119a optically reads a two-dimensional code. The control portion includes a CPU, memory, and the like that control the cash dispensing portion 119b and the two-dimensional code reader portion 119a for executing cash transactions.

Action according to the third embodiment performed by the above-described structural elements will be described. Note that, operations of the smartphone 117, the cooperative server 115, the host computer 113, and the monitor-less ATM 119 (to be described later) are controlled by the respective control portions thereof (not illustrated) on the basis of programs (software) stored in the respective storage portions (not illustrated) thereof.

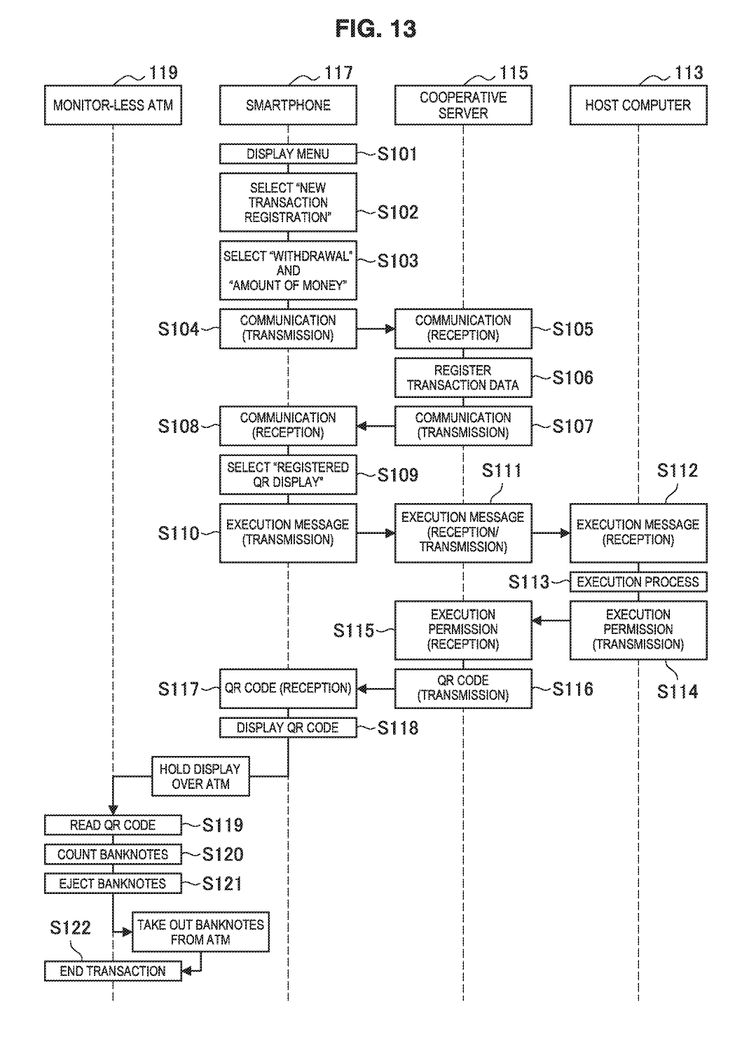

FIG. 13 is an explanatory diagram illustrating a process workflow performed when a cash withdrawal process is executed by the host computer 113, the cooperative server 115, the smartphone 117, and the monitor-less ATM 119 according to this embodiment. Here, an example in which a customer requests cash withdrawal of 30,000 yen will be described in accordance with steps illustrated in FIG. 13. Note that, in the following description, access operation before usage of the internet banking, such as access operation before reaching a transaction menu screen will be omitted.

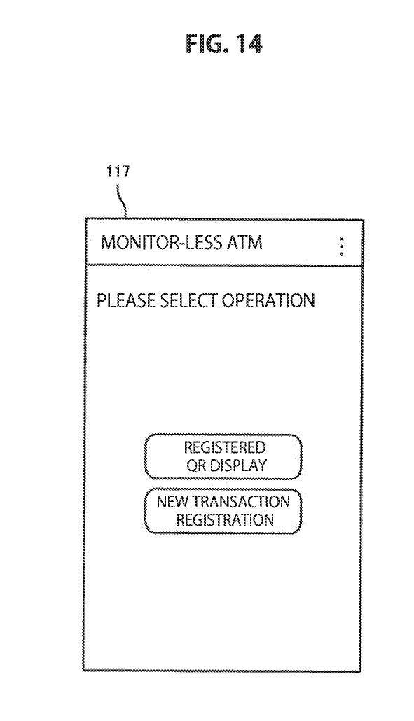

First, the customer connects with the cooperative server 115 of the internet banking through the app in the smartphone 117, and opens a menu operation selection screen illustrated in FIG. 14 (S101).

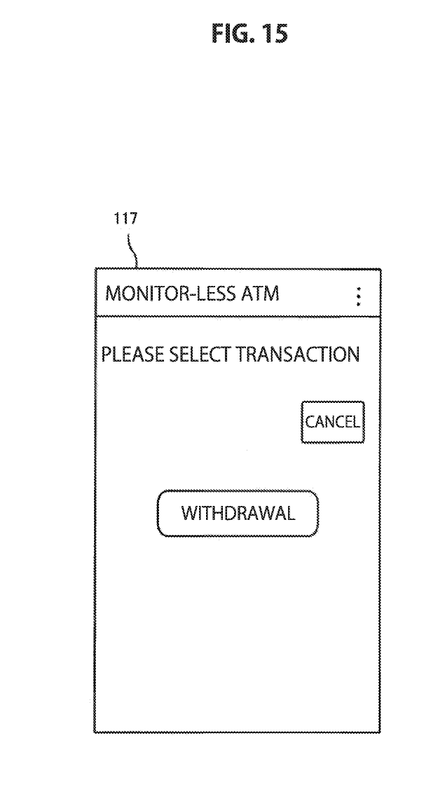

The customer taps and selects “NEW TRANSACTION REGISTRATION” displayed on the menu operation selection screen of the smartphone 117 illustrated in FIG. 14, and opens a menu transaction selection screen illustrated in FIG. 15 (S102).

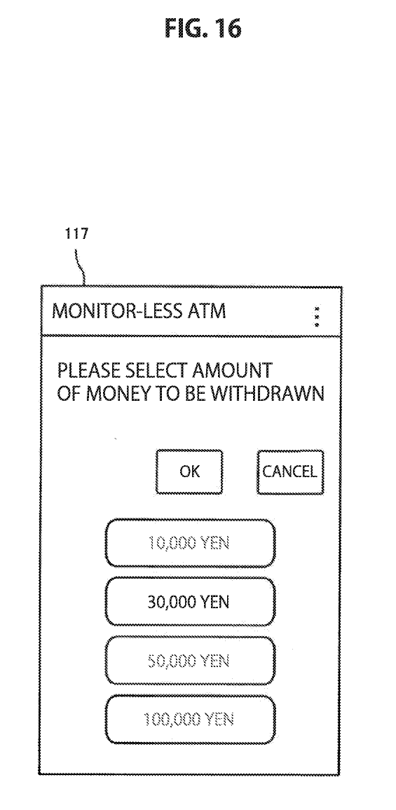

Next, the customer taps and selects “WITHDRAWAL” that is a desired transaction on the menu transaction selection screen illustrated in FIG. 15, opens a menu money amount selection screen illustrated in FIG. 16, taps and selects the amount of money “30,000 YEN” on the menu screen in FIG. 16, taps “OK”, and confirms it (S103). Note that, in the case where the customer taps “CANCEL”, the transaction is not executed and the process returns to the menu operation selection screen illustrated in FIG. 14.

After the operation of tapping “OK”, the smartphone 117 transmits transaction data to the cooperative server 115 (S104). The cooperative server 115 that has received the transaction data (S105) performs a registration process on the transaction data (S106) and transmits a response indicating that the transaction data is registered to the smartphone 117 (S107). The smartphone 117 receives the response from the cooperative server 115 (S108). Here, the smartphone 117 returns to the menu operation selection screen illustrated in FIG. 14.

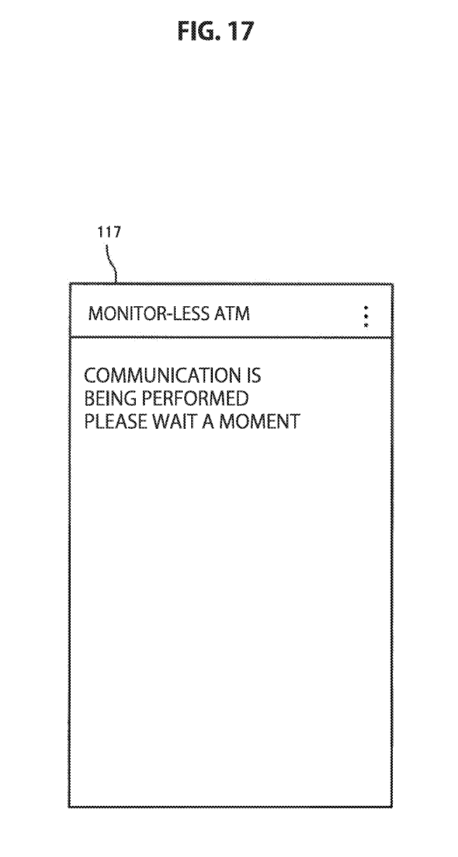

Next, the customer taps and selects “REGISTERED QR DISPLAY” on the screen of the smartphone 117 (S109), and the smartphone 117 displays information indicating that communication is being performed (S109) as illustrated in FIG. 17.

After the operation of tapping “REGISTERED QR DISPLAY”, the smartphone 117 transmits an execution message based on the transaction data to the host computer 113 via the cooperative server 115 (S110 and S111). The host computer 113 that has received the execution message (S112) performs an execution process on the execution message (S113) and transmits a response indicating permission for the execution to the cooperative server 115 (S114). In the execution process, the host computer 113 searches the transaction information for account information of the customer, compares the balance of the account with the amount of cash to be dispensed based on the transaction information, and registers the permission for the execution when there is no problem such as insufficient funds.

When the response of permission is received (S115), the cooperative server 115 generates a two-dimensional code including a content indicating that it is possible to dispense “30,000 YEN”, and transmits data of a two-dimensional code pattern representing the content to the smartphone 117 (S116).

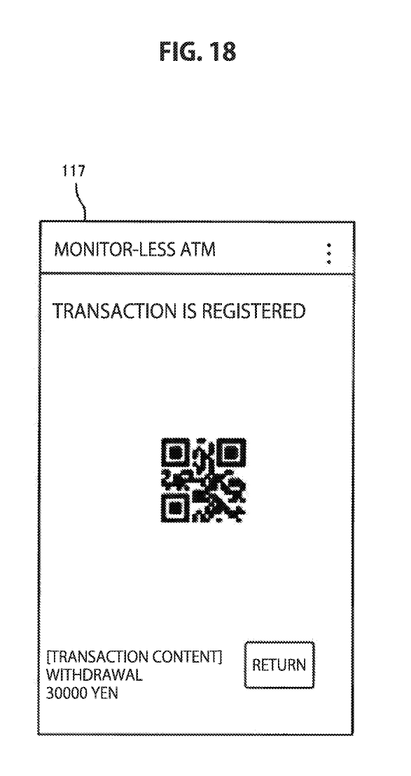

The smartphone 117 receives the data of the two-dimensional code pattern representing the preliminarily registered content from the cooperative server 115 (S117), and displays a transaction registration screen including the two-dimensional code representing the preliminarily registered content illustrated in FIG. 18 a predetermined period of time (a period of time necessary for the customer to hold the smartphone 117 over the two-dimensional code reader portion 119a to cause the two-dimensional code reader portion 119a to read it, such as one minute (S118). Note that, in the case where the customer taps “RETURN” at this time, the transaction is not executed and the smartphone 117 returns to the menu operation selection screen illustrated in FIG. 14. As described above, the smartphone 117 asks the host computer 113 whether or not it is possible to execute a transaction via the cooperative server 115, and the cooperative server 115 receives a result thereof. The cooperative server 115 transmits data of the two-dimensional code to the smartphone 117 as the transaction permission information, and the smartphone 117 receives the data of the two-dimensional code and displays the two on the screen of the smartphone 117.

The customer places the smartphone 117 on the two-dimensional code reader portion 119a of the monitor-less ATM 119 such that the two-dimensional code displayed on the smartphone 117 is held over the two-dimensional code reader portion 119a.

The monitor-less ATM 119 reads the two-dimensional code held over the two-dimensional code reader portion 119a (S119), counts banknotes in accordance with record of the two-dimensional code (S120), and ejects banknotes corresponding to “30,000 YEN” for the customer (S121). The customer takes out the ejected banknotes, and the transaction with the monitor-less ATM 119 ends (S122).

According to the third embodiment, communication is established with the host computer 113 via the cooperative server 115 before displaying the two-dimensional code to be input to the monitor-less ATM, and the two-dimensional code is displayed on the smartphone 117 in the case where the withdrawal is permitted. Accordingly, it is possible to check that the transaction is permitted by the host computer 113.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

### Modification

In the first embodiment, the cooperative server 115 receives transaction permission information, generates data of a two-dimensional code, and transmits the data to the smartphone 117 as illustrated in Steps S115 to S118 in FIG. 13. In this modification, it is possible for the smartphone 117 that has received the transaction permission information from the cooperative server 115 to generate the data of the two-dimensional code and display the two-dimensional code.

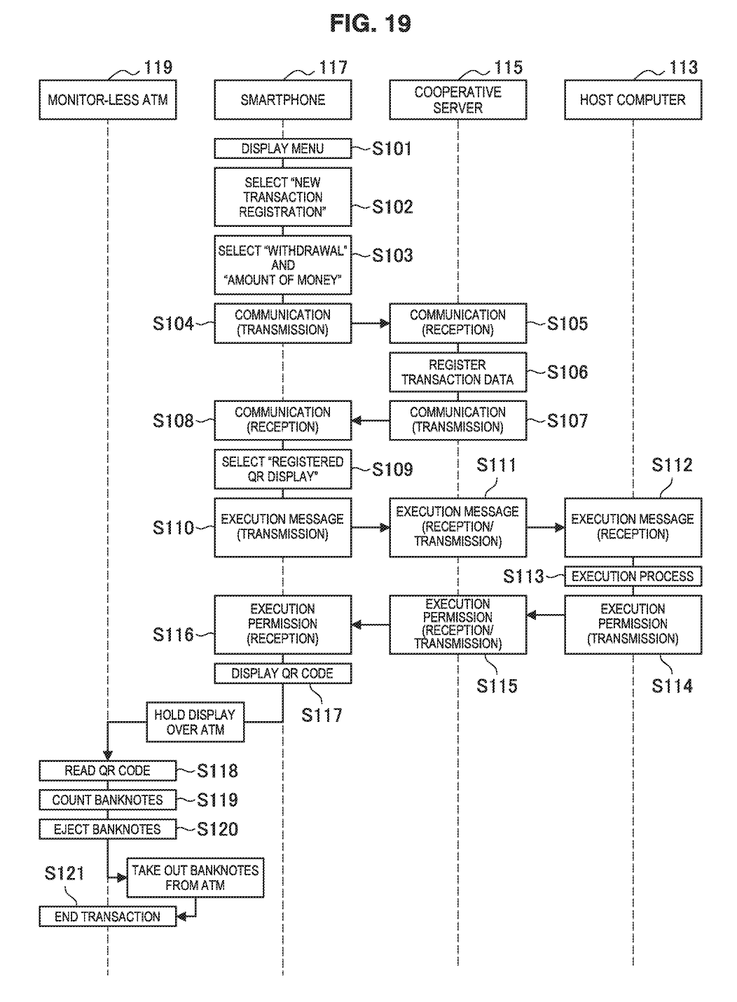

FIG. 19 is an explanatory diagram illustrating a process workflow performed by the smartphone 117 when a cash withdrawal process is executed according to the modification of the third embodiment. Steps S111 to S114 in FIG. 19 are similar to Steps S111 to S114 in FIG. 13, and Steps S117 to S121 in FIG. 19 are similar to Steps S118 to S122 in FIG. 13. Therefore, description of these steps will be omitted.

As illustrated in FIG. 19, the cooperative server 115 that has received a response indicating permission for execution from the host computer 113 (S115) transmits the response to the smartphone 117 (S115). Next, the smartphone 117 generates a two-dimensional code including a content indicating that it is possible to dispense “30,000 YEN” on the basis of the received response indicating the permission (S116), and displays the two-dimensional code pattern on its screen (S117).

According to the modification of the third embodiment, it is possible to shorten time before displaying the two-dimensional code pattern on the screen.

### Fourth Embodiment

In the fourth embodiment, the customer operates the smartphone 117 such that a transaction result is registered on the host computer 113 after the customer takes out the ejected banknotes and the transaction with the monitor-less ATM 119 ends as described in the third embodiment. This enables the smartphone 117 to communicate with the host computer 113 via the cooperative server 115 and enables host computer 113 to recognize the transaction result.

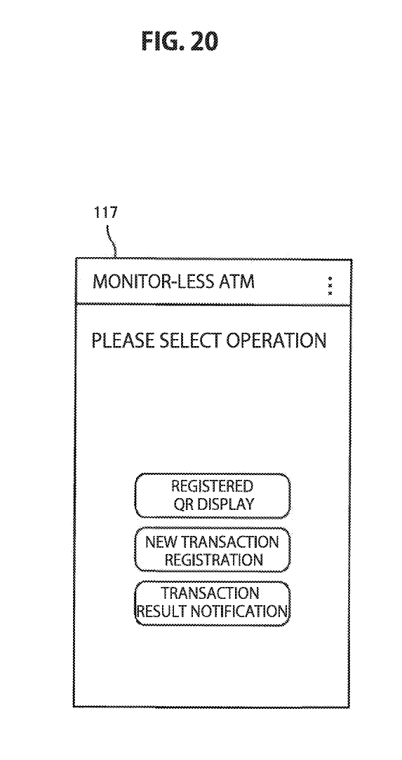

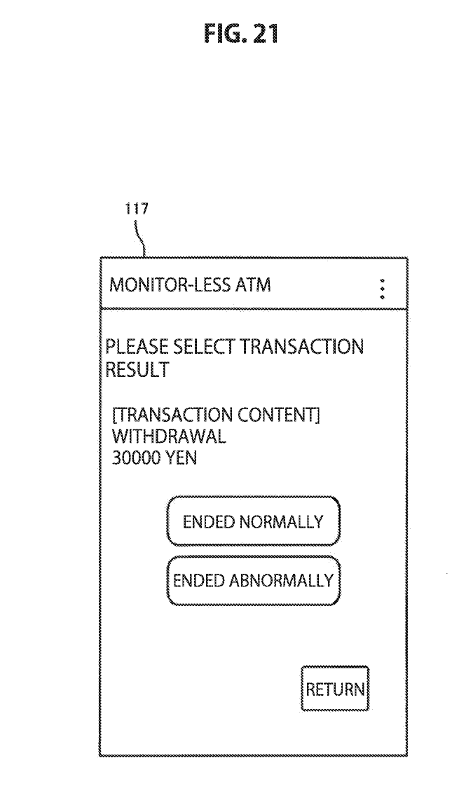

FIG. 20 illustrates a menu operation selection screen on the smartphone 117 according to the fourth embodiment. FIG. 21 illustrates a menu transaction result registration screen on the smartphone 117 according to the fourth embodiment.

After taking out the banknotes, the customer subsequently taps and selects “TRANSACTION RESULT NOTIFICATION” on the menu operation selection screen of the smartphone 117 illustrated in FIG. 20, and opens the menu transaction result registration screen illustrated in FIG. 21. Next, the customer taps and selects “ENDED NORMALLY” or “ENDED ABNORMALLY” as a transaction result. Here, the smartphone 17 transmits the transaction result to the host computer 113 via the cooperative server 115. The smartphone 117 receives a response from the host computer 113 via the cooperative server 115, and returns to the menu operation selection screen illustrated in FIG. 20.

According to the fourth embodiment, since the transaction result is registered through the customer operation using the smartphone 117 after the transaction ends, it is possible for the smartphone 117 to communicate with the host computer 113 via the cooperative server 115, and it is possible for the host computer 113 to recognize the transaction result.

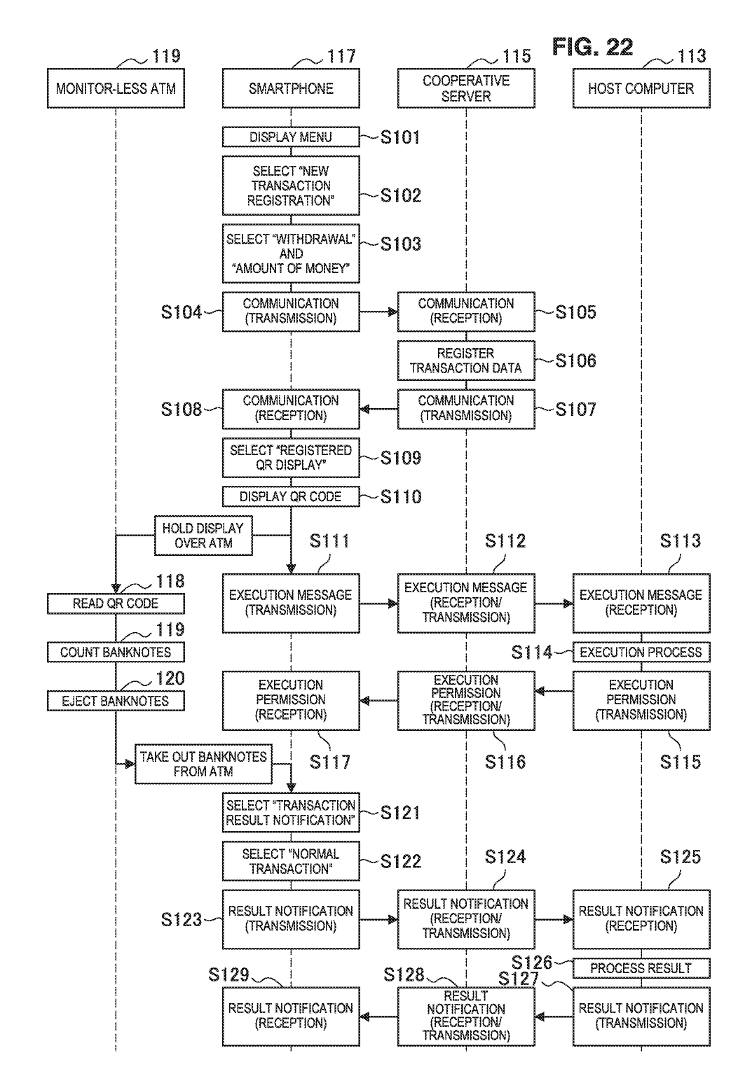

FIG. 22 is an explanatory diagram illustrating a process workflow performed by the smartphone 117 when a cash withdrawal process is executed according to a specific example of the fourth embodiment. Steps S101 to S108 in FIG. 22 are similar to Steps S101 to S108 in FIG. 13 except for the menu operation selection screen (FIG. 20). Therefore, description of these steps will be omitted.

As illustrated in FIG. 22, the smartphone 117 receives a response indicating that the transaction data is registered from the cooperative server 115 (S108), and displays the menu operation selection screen illustrated in FIG. 20 (S109). Here, the smartphone 117 generates a two-dimensional code including a content indicating that it is possible to dispense “30,000 YEN” on the basis of the response indicating that the transaction data is registered, and the smartphone 117 displays the two-dimensional code pattern on its screen (S110).

After displaying the two-dimensional code pattern, the smartphone 117 transmits an execution message based on the transaction data to the host computer 113 via the cooperative server 115 (S111 and S112). The host computer 113 that has received the execution message (S113) performs an execution process on the execution message (S114) and transmits a response indicating permission for the execution to the cooperative server 115 (S115).

The cooperative server 15 that has received the response indicating permission for execution from the host computer 113 (S116) transmits the response to the smartphone 117, and the smartphone 117 receives it (S117). The smartphone 117 switches its screen to the menu operation selection screen illustrated in FIG. 20.

On the other hand, after display of the two-dimensional code pattern (S110), the customer holds the two-dimensional code displayed on the smartphone 117 over the two-dimensional code reader portion 119a of the monitor-less ATM 119.

The monitor-less ATM 119 reads the two-dimensional code held over the two-dimensional code reader portion 119a (S118), counts banknotes in accordance with record of the two-dimensional code (S119), and ejects banknotes corresponding to “30,000 YEN” for the customer (S120). The customer takes out the ejected banknotes, and the transaction with the monitor-less ATM 119 ends.

The customer 117 removes the smartphone 117 from the two-dimensional code reader portion 119a of the monitor-less ATM 119. The customer taps and selects “TRANSACTION RESULT NOTIFICATION” on the menu operation selection screen of the smartphone 117 illustrated in FIG. 20 (S121), and opens the menu transaction result registration screen illustrated in FIG. 21. Next, the customer taps and selects “ENDED NORMALLY” as a transaction result (S122). Note that, in the case where the customer taps “RETURN” at this time, the transaction is not executed and the smartphone 117 returns to the menu operation selection screen illustrated in FIG. 20. Alternatively, it is not necessary for the smartphone 117 to display “RETURN” on the menu transaction result registration screen illustrated in FIG. 21. It is possible for the smartphone 117 to return to the menu operation selection screen illustrated in FIG. 20 after displaying the menu transaction result registration screen a predetermined period of time.

After “ENDED NORMALLY” is tapped, the smartphone 17 transmits a transaction result notification to the host computer 113 via the cooperative server 115 (S123 and S124). Note that, although the menu transaction result registration screen in FIG. 21 displays “ENDED NORMALLY” and “ENDED ABNORMALLY”, it is also possible to display “ENDED ABNORMALLY” only and transmit a transaction result notification to the host computer 113 via the cooperative server 115 after displaying “ENDED ABNORMALLY” a predetermined period of time without being tapped (S123 and S124). The host computer 113 that has received the transaction result notification (S125) processes the transaction result notification (S126) and transmits the result notification to the cooperative server 15 (S127). When receiving a notification indicating that the cash dispensing process has ended, the host computer 113 adds information indicating cash dispensing completion to the corresponding transaction information registered on the host computer 113 and updates the balance in the corresponding account, as a transaction result notification process. Note that, as the transaction result notification process, it is also possible to record a log in the step (S120) of ejecting the banknotes from the monitor-less ATM 119 (for example, to record output from a detection sensor that has detected ejected banknotes or the like), collect the log at the time of restocking with banknotes, and update the balance in the corresponding account in the host computer 13 by using the log.

The cooperative server 115 that has received the result notification from the host computer 113 (S128) transmits the response to the smartphone 117, and the smartphone 117 receives it (S129). The smartphone 117 switches its screen to the menu operation selection screen illustrated in FIG. 20.

According to the above-described embodiment, communication is established with the host computer 113 via the cooperative server 115 before displaying a two-dimensional code to be input to the monitor-less ATM 119, and the two-dimensional code is displayed on the smartphone 117 in the case where the transaction is permitted. Accordingly, it is possible to check that the transaction is permitted by the host computer 113. In addition, since the transaction result is registered through the customer operation using the smartphone 117 after the transaction ends, it is possible for the smartphone 117 to communicate with the host computer 113 via the cooperative server 115 and cause the host computer 113 to recognize the transaction result.

According to the above-described embodiments, the monitor-less ATM 119 does not include a wired/wireless communication portion, but uses a mobile communication terminal of a customer for communication with a host computer. Therefore, it is not necessary to prepare an ATM monitoring system that monitors communication via such a communication portion. Accordingly, it is possible to reduce facility cost and monitoring cost such as a cost for wiring work.

In addition, it is not necessary to install a reader mechanism portion (card reader) for ATM cards in the ATM. Therefore, it is possible to reduce the size of the ATM.

In addition, in the above-described embodiments, a transaction request is received by the internet banking, a customer account is acquired at the same time, the customer account, a transaction type, and the amount of money are registered as transaction information on a host computer, and an ATM executes a transaction on the basis of the transaction information. Therefore, it is not necessary to issue ATM cards for accounts of the internet banking. It is possible to reduce cost for issuing cards of financial institutions.

Additionally, the present technology may also be configured as below.

(1)

A mobile communication terminal that connects with a network including an online banking server, operates cooperatively with an automated cash transaction machine, and includes a display portion, the mobile communication terminal including:

a registration means for preliminarily registering a content of a cash transaction on the online banking server via the network;

a permission request means for requesting permission for the cash transaction from the online banking server; and

a display means for displaying a code pattern representing the preliminarily registered content of the cash transaction on the display portion while waiting for reception of the permission or after receiving the permission.

(2)

The mobile communication terminal according to (1),

in which the code pattern is generated when the permission is received via the network.

(3)

The mobile communication terminal according to (1),

in which, when the permission is received, the online banking server generates data of the code pattern and transmits the data of the code pattern to the mobile communication terminal.

(4)

The mobile communication terminal according to any one of (1) to 3,

in which, after the display means displays the code pattern a predetermined period of time, a result of the cash transaction is displayed and the result of the cash transaction is transmitted to the online banking server.

(5)

The mobile communication terminal according to claim 1,

in which the automated cash transaction machine is an offline machine that does not connect with the network.

(6)

An automated cash transaction system including:

the mobile communication terminal according to any one of (1) to 4; and

an automated cash transaction machine that does not connects with the network, that includes a reader portion configured to read the code pattern displayed on the display portion, and that executes a cash transaction in accordance with the code pattern.

(7)

A program that causes a mobile communication terminal to execute a cash transaction process, in which

the mobile communication terminal connects with a network including an online banking server, operates cooperatively with an automated cash transaction machine, and includes a display portion, and

the program causes the mobile communication terminal to function as
a registration means for preliminarily registering a content of a cash transaction on the online banking server via the network,
a permission request means for requesting permission for the cash transaction from the online banking server, and
a display means for displaying a code pattern representing the preliminarily registered content of the cash transaction on the display portion while waiting for reception of the permission or after receiving the permission.
   (8)

An automated cash transaction machine

that is offline,

that does not connect with a network,

that includes a reader portion configured to optically read a code pattern, and

that executes a cash transaction in accordance with the code pattern.

(9)

The automated cash transaction machine according to (8), further including:

a mechanism portion configured to classify, count, convey, and eject a banknote; and

a control portion configured to control the mechanism portion and the reader portion to execute the cash transaction.

### REFERENCE SIGNS LIST

10, 70 automated transaction system
60, 90 automated transaction machine
61, 91 transaction data reception portion
62, 92 transaction execution portion
63 transaction result transmission portion
64 transaction history holding portion
94 operational state transmission portion
50 communication terminal
52 transaction data generation portion (program)
111 internet banking system
115 cooperative server
113 host computer
117 smartphone
119 monitor-less ATM
119a two-dimensional code reader portion
119b cash dispensing portion

1. An automated transaction machine comprising:
a transaction data reception portion configured to receive transaction data generated by a communication terminal connectable with a host computer, the transaction data including a content of a transaction with a user of the communication terminal;
a transaction execution portion configured to execute the transaction with the user on the basis of the transaction data received by the transaction data reception portion; and
a transaction result transmission portion configured to transmit a result of a transaction with at least one user executed by the transaction execution portion, to the host computer via a communication terminal whose transaction data has been received by the transaction data reception portion.

2. The automated transaction machine according to claim 1,
wherein the transaction execution portion executes the transaction with the user by using only the transaction data received by the transaction data reception portion.

3. The automated transaction machine according to claim 1, comprising
a short-range wireless communication portion configured to communicate with the communication terminal whose transaction data has been received by the transaction data reception portion through short-range wireless communication,
wherein the transaction result transmission portion communicates with the host computer via the communication terminal alone.

4. The automated transaction machine according to claim 1, comprising
a transaction history holding portion configured to hold a result of a transaction executed by the transaction execution portion as a transaction history,
wherein the transaction result transmission portion transmits the transaction history held by the transaction history holding portion to the host computer via the communication terminal whose transaction data has been received by the transaction data reception portion, and deletes the transaction history after transmitting the transaction history.

5. The automated transaction machine according to claim 4,
wherein the transaction history holding portion holds a result of the transaction that the transaction result transmission portion has failed to transmit, as a transaction history.

6. (canceled)

7. (canceled)

8. An automated transaction system comprising:
a communication terminal that is portable and connectable with a host computer, and
an automated transaction machine that is connectable with the communication terminal,
wherein the communication terminal includes
a transaction data generation portion configured to generate transaction data including a content of a transaction with a user, and
an interface configured to output the transaction data generated by the transaction data generation portion to the automated transaction machine, and
the automated transaction machine includes
a transaction data reception portion configured to receive the transaction data via the interface;
a transaction execution portion configured to execute the transaction with the user on the basis of the transaction data received by the transaction data reception portion; and
a transaction result transmission portion configured to transmit a result of a transaction with at least one user executed by the transaction execution portion, to the host computer via the communication terminal whose transaction data has been received by the transaction data reception portion.

9. (canceled)

10. An automated transaction machine comprising:
a transaction data reception portion configured to receive transaction data generated by a communication terminal connectable with a host computer, the transaction data including a content of a transaction with a user of the communication terminal;
a transaction execution portion configured to execute the transaction with the user on the basis of the transaction data received by the transaction data reception portion; and
an operational state transmission portion configured to transmit an operational state of the transaction execution portion to the host computer via the communication terminal, the operational state being obtained when the transaction data reception portion has received the transaction data.

11. The automated transaction machine according to claim 10,
wherein the transaction execution portion executes the transaction with the user by using only the transaction data received by the transaction data reception portion.

12. The automated transaction machine according claim 10, comprising
a short-range wireless communication portion configured to communicate with the communication terminal whose transaction data has been received by the transaction data reception portion through short-range wireless communication,
wherein the operational state transmission portion communicates with the host computer via the communication terminal alone.

13. A communication terminal that is portable, the communication terminal comprising:
a transaction data generation portion configured to generate transaction data including a content of a transaction with a user;
an interface configured to output the transaction data generated by the transaction data generation portion to an automated transaction machine, and cause the automated transaction machine to execute the transaction with the user; and
a telephone network communication portion configured to communicate with a host computer via a telephone network, and transmit an operational state of the automated transaction machine to the host computer, the operational state being obtained when the interface has output the transaction data to the automated transaction machine.

14. The communication terminal according to claim 13, wherein
the transaction data generation portion generates a QR code (registered trademark) as the transaction data, and
the interface includes a display configured to display the QR code (registered trademark).

15. The communication terminal according to claim 14,
wherein the display displays an operational state of the automated transaction machine obtained when the automated transaction machine has received the QR code (registered trademark).

16. An automated transaction system comprising:
a communication terminal that is portable and connectable with a host computer, and
an automated transaction machine that is connectable with the communication terminal,
wherein the communication terminal includes
a transaction data generation portion configured to generate transaction data including a content of a transaction with a user, and
an interface configured to output the transaction data generated by the transaction data generation portion to the automated transaction machine, and
the automated transaction machine includes
a transaction data reception portion configured to receive the transaction data via the interface;
a transaction execution portion configured to execute the transaction with the user on the basis of the transaction data received by the transaction data reception portion; and
an operational state transmission portion configured to transmit an operational state of the transaction execution portion to the host computer via the communication terminal, the operational state being obtained when the transaction data reception portion has received the transaction data.

17. A program that causes a communication terminal to operate as:
a transaction data generation portion configured to generate transaction data including a content of a transaction with a user;
an interface configured to output the transaction data generated by the transaction data generation portion to an automated transaction machine, and cause the automated transaction machine to execute the transaction with the user; and
a telephone network communication portion configured to communicate with a host computer via a telephone network, and transmit an operational state of the automated transaction machine to the host computer, the operational state being obtained when the interface has output the transaction data to the automated transaction machine.

18. A mobile communication terminal comprising:
a permission request portion configured to request a server to permit a cash transaction with an automated transaction machine via a network;
a display portion configured to display a code that is used by the automated transaction machine to execute the cash transaction; and
a transmission portion configured to transmit a transaction result of the cash transaction via the network after reception of the transaction result from a customer,
wherein the automated transaction machine is an offline machine that does not connect with the network, and
the transaction result indicates that the automated transaction machine has processed cash normally or abnormally.

19. The mobile communication terminal according to claim 18,
wherein a case where the cash is processed normally means that the customer has taken out the cash from a cash dispensing portion, or means that the cash has been ejected into the cash dispensing portion in accordance with a content of the cash transaction.

20. The mobile communication terminal according to claim 18,
wherein a case where the cash is processed abnormally means that the cash has remained in a cash dispensing portion for a predetermined period of time, or means that cash that does not correspond to a content of the cash transaction has been ejected into the cash dispensing portion.

21. The mobile communication terminal according to claim 18,
wherein the display portion displays the code in a case where the permission is transmitted to the mobile communication terminal.

22. The mobile communication terminal according to claim 18,
wherein the server transmits the code to the mobile communication terminal in a case where the cash transaction is permitted.

23. The mobile communication terminal according to claim 18,
wherein the display portion displays a screen for causing the customer to confirm the transaction result.

24. A non-transitory computer readable medium comprising instructions for execution by a control portion of a mobile communication terminal, the instructions comprising:
requesting a server to permit a cash transaction to be executed by an automated transaction machine via a network;
displaying a code that is used by the automated transaction machine to execute the cash transaction; and
transmitting a transaction result of the cash transaction via the network after reception of the transaction result from a customer,
wherein the transaction result indicates that the automated transaction machine has processed cash normally or abnormally.
